(19) United States
(12) Patent Application Publication
(10) Pub. No.: US 2026/0010284 A1
(43) Pub. Date: Jan. 8, 2026

(54) Rapid Display Prototyping and Creation Using Gestures

(71) Applicant: FISHER-ROSEMOUNT SYSTEMS, INC., Round Rock, TX (US)

(72) Inventors: Cristopher Ian Sarmiento Uy, Metro Manila (PH); Julian K. Naidoo, Cedar Park, TX (US); Andrew E. Cutchin, Killeen, TX (US); Nilesh Chordiya, Pune (IN)

(21) Appl. No.: 18/763,142

(22) Filed: Jul. 3, 2024

(51) Int. Cl. G06F 3/04883; G06F 3/04817; G06F 3/0482

(52) U.S. Cl. CPC G06F 3/04883; G06F 3/04817; G06F 3/0482

(57) ABSTRACT

Systems and methods are described with respect to a display creation application that provides an interactive graphical environment by which a user can configure a process display associated with operation of a process plant. More specifically, the display creation application implements a gesture recognition algorithm configured to translate user-provided gestures (e.g., lines or shapes drawn on a touchpad or touchscreen) to template objects representative of entities in the process plant, each template having various preconfigured parameters, behaviors, animations, etc. associated therewith. By interconnecting and configuring templates, the user can create and configure a process display to be used by a viewing application to monitor and/or control a process plant.

### TECHNICAL FIELD

The present application relates generally to process control systems, and more particularly, to generating visual displays of process control plant environments.

### BACKGROUND

Distributed process control systems, like those used in chemical, petroleum or other process plants, typically include one or more process controllers communicatively coupled to one or more field devices via analog, digital or combined analog/digital buses, or via a wireless communication link or network. The field devices, which may be, for example, valves, valve positioners, switches and transmitters (e.g., temperature, pressure, level and flow rate sensors), are located within the process plant environment and generally perform physical or process control functions such as opening or closing valves, measuring process parameters, etc. to control one or more processes executing within the process plant. Smart field devices, such as the field devices conforming to the well-known Fieldbus protocol may also perform control calculations, alarming functions, and other control functions commonly implemented within a process controller. The process controllers, which are also typically located within the plant environment, receive signals indicative of process measurements made by the field devices and/or other information pertaining to the field devices and execute a controller application that runs, for example, different control modules which make process control decisions, generate control signals based upon the received information and coordinate with the control modules or blocks being performed in the field devices, such as HART®, WirelessHART®, and FOUNDATION® Fieldbus field devices. The control modules in the controller send the control signals over the communication lines or links to the field devices to thereby control the operation of at least a portion of the process plant or system.

Information from the field devices and the controller is usually made available over a data highway to one or more other hardware devices, such as operator workstations, personal computers or computing devices, data historians, report generators, centralized databases, or other centralized administrative computing devices that are typically placed in control rooms or at other locations away from the harsher plant environment. Each of these hardware devices typically is centralized across the process plant or across a portion of the process plant. These hardware devices run applications that may, for example, enable an operator to perform functions with respect to controlling a process and/or operating the process plant, such as changing settings of the process control routines, modifying the operation of the control modules within the controllers or the field devices, viewing the current state of the process, viewing alarms generated by field devices and controllers, simulating the operation of the process for the purpose of training personnel or testing the process control software, keeping and updating a configuration database, etc. The data highway utilized by the hardware devices, controllers and field devices may include wired communication paths, wireless communication paths, or a combination of wired and wireless communication paths.

As an example, the DeltaV™ control system, sold by Emerson Process Management, includes multiple applications stored within and executed by different devices located at diverse places within a process plant. A process configuration application, which resides in one or more workstations or computing devices, may include a process module configuration application that enables users to create or change process control modules and download these process control modules via a data highway to dedicated distributed controllers. Typically, these control modules are made up of communicatively interconnected function blocks, which are objects in an object-oriented programming protocol that perform functions within the control scheme based upon inputs thereto and that provide outputs to other function blocks within the control scheme. The process configuration application may also include a process display creation application that enables creation and editing of visual operator interfaces (or “process displays”), which are used by a viewing application to display information associated with the process environment to an operator and to enable the operator to change settings, such as set points, within the process control routines. Each dedicated controller and, in some cases, one or more field devices, stores and executes a respective controller application that runs the control modules assigned and downloaded thereto to implement actual process control functionality.

The viewing application, which may be executed on one or more operator workstations or field devices (or on one or more remote computing devices in communicative connection with the operator workstations and the data highway), receives data from the controller application via the data highway and display this data to process control system designers, operators, or users using the user interfaces, and may provide any of a number of different views, such as an operator's view, an engineer's view, a technician's view, etc. A data historian application is typically stored in and executed by a data historian device that collects and stores some or all of the data provided across the data highway while a configuration database application may run in a still further computer attached to the data highway to store the current process control routine configuration and data associated therewith. Alternatively, the configuration database may be located in the same workstation as the configuration application.

The display creation application typically includes a library of process template objects or “dynamos,” including for example function block templates, control module templates, field device templates, network device templates, etc. The configuration application is used to configure a control strategy for a process plant and to provide display views at user interfaces of a process plant. The templates all have default visual appearances, properties, settings and methods associated therewith. The user of the configuration application (e.g., a lead configuration engineer) can select these templates and essentially place copies or “instances” of the selected templates into a configuration screen to develop a module, e.g., a control module or process display. During the process of selecting and placing the template object instances into the configuration screen, the user interconnects the inputs and outputs of these template object instances and changes their parameters, names, tags and other properties to create a specific control module for a specific use in the process plant. After creating one or more such control modules, the user may store the created module in the library or in a configuration data storage area. The user can then instantiate the control module (e.g., cause an executable file corresponding to the control module to be created) and download it to the appropriate controller or controllers, field devices, and other process elements for execution during operation of the process plant.

Thereafter, the user can use the display creation application to create one or more process displays for operators, technicians, and/or other personnel within the process plant. In a manner similar to the configuration of control strategies, the creation of process displays involves selecting, arranging, and configuring instances of graphical templates or dynamos in a configuration screen, or more particularly in a “canvas region” defined therein. The user may arrange and interconnect, for example, graphical representations of tanks, valves, sensors, operator control buttons, switches, status indicators, network devices, etc., to create an operator display, maintenance display, or the like (referred to herein simply as “process display”). Effectively, each instance of a template object placed in the configuration screen is representative of a physical or logical entity in the process plant, e.g., a field device (e.g., valve positioner, switch, transmitter, sensor, etc.), another process equipment item (e.g., a vessel, conveyor, etc.), a process equipment connector (e.g., process fluid line or pipe), a process data network entity (e.g., a big data storage/transmission device or a data communication wire), etc. Each template object can have various properties such as parameters, settings, methods, animation expressions, event handler behaviors, etc., with those properties being customizable for each placed instance of the template object. For example, a template object for a process fluid line may include properties defining dimensions of the fluid line, animations for depicting the flow of process fluid through the fluid line in a process display, status indicators for displaying temperatures or other measured properties of process fluid, and/or event handler behaviors for visually depicting phenomena detected in the fluid line (e.g., a warning for a blockage in the fluid line). Upon placing an instance of a template object on the canvas, the user may modify the properties of the instance, i.e., separately from other instances of the template object and without modifying the underlying template object itself.

The process displays are typically implemented on a system wide basis in one or more of the workstations and provide preconfigured displays to the operator or maintenance personnel regarding the operating state of the process control system as a whole, or at least a portion of physically or logically interconnected entities in the process control system (a “process module”). Often, these process displays take the form of alarming displays that receive and display alarms or other status indicators generated by controllers or devices within the process plant, control displays indicating the operating state of the controllers and other devices being controlled within the process plant, maintenance displays indicating the functioning state of the devices within the process plant, etc. These displays are generally preconfigured to display, in known manners, information or data received from the process control modules, devices, or other process elements within the process plant. During execution of a process display, a placed template object instance may, for example, change the graphic on the display screen based upon the received data to illustrate that a tank is half full, to illustrate the fluid flow measured by a flow sensor, to show an alarm, etc. In some implementations, the operator display may further be utilized to make changes in the process plant, e.g., to change a setting for a field device or to shut down a device in response to an alarm. Thus, once linked to a process environment, a process display provides real-time means for viewing and/or modifying aspects of at least a portion of the process control system of the process plant depicted in the display. It may be desirable to create a large number of process displays corresponding to respective portions of the process control system, with particular displays serving the diverse needs of process engineers, operators, maintenance staff, etc.

In view of the above, creating a process display typically requires at least (1) knowledge of the layout of the process plant or the module therein that the process module is to depict (e.g., knowledge of the relative arrangement and functions of field devices, process controllers, etc.), and (2) familiarity with the functions of the display creation application itself (e.g., familiarity with the means for selecting, arranging, and configuring instances of process templates in the canvas region). Accordingly, creation of the process display typically requires the involvement of at least (1) process plant personnel having knowledge of the process control system (e.g., a process engineer), as well as (2) a process display creation expert having specific familiarity with the display creation application (e.g., the menus, templates, etc. involved therein). A process engineer may, for example, provide a hand-drawn sketch of the process plant or module, indicating a desired layout of a process display (e.g., size and placement of the entities to be depicted, and the relationships of the entities to each other). Alternatively, the process engineer might use a generic software tool (e.g., office presentation software or native desktop drawing software) to draft a digital mockup of the process plant or module, and provide the digital mockup to the display creation expert. In either case, the display creation expert consults the sketch or mockup and uses the display creation application to draft a process display serving the requirements of process plant personnel. This method for creating process displays, though, often requires multiple iterative development phases, in each of which the process engineer must review the drafted process display and provide feedback and/or additional requirements for the display creation expert, based upon which the display creation expert generates and/or modifies the display.

Thus, the creation of a process display often imposes significant burdens upon both a process engineer and a display expert. These burdens are multiplied by the need for a large number of process displays to serve the various respective requirements of process plant personnel. It would be desirable for one technical user having knowledge of a process plant or module (e.g., a process engineer) to be individually able to create a process display to serve his or her own operational needs, using his or her own knowledge of the process plant or module.

### SUMMARY

A display creation application allows a user to provide gestures onto a gesture input region (e.g., in a canvas region of a graphical user interface (GUI), or as hand gestures in front of one or more camera devices) to indicate process entities to be included in a process display for use by an operator, maintenance technician, and/or other process plant personnel. The user, generally speaking, provides gestures to “draw” lines and/or shapes in a gesture input region to indicate field devices, control devices, network devices, and/or other entities in a process plant or module to be visually represented in the process display.

Responsive to receiving one or more gestures, the display creation application implements a gesture recognition algorithm to translate the line or shape formed by the one or more gestures to a process entity and a corresponding process template object for inclusion in the process display. Upon identifying a template object to be displayed, the GUI provides an instance of the template object in a canvas region of the GUI. The user may subsequently rearrange and configure the placed template object instance (e.g., dimensions, event handler behaviors, and/or other properties) to form a portion of the process display. Effectively, by automatically translating gestures to preconfigured process template objects, the display creation application as described herein allows for simple and intuitive design of a process display, even if the user has only minimal prior familiarity with the display creation application or the library of process template objects included therein.

The display creation application is implemented at a user device which may include, for example, a process engineer workstation, a portable computing device (e.g., tablet) carried by process plant personnel, and/or another suitable device. The user device includes a display unit (e.g., a touchscreen display) that displays the interactive GUI for creating a process display. The user device may additionally include an input unit and/or camera for receiving gestures and/or other user input. An input device may include a touchscreen, a touchpad, and/or mouse for receiving gestures, a keyboard and/or microphone to receive other forms of user input, and/or other components. The input unit may be integrated with or otherwise spatially mapped to the display unit, such that gestures received via a location of the input unit are displayed in a corresponding location at the display unit. Additionally, or alternatively, the user device may be configured to receive gestures and/or other user input via the camera, e.g. by mapping gestures (e.g., hand gestures) detected via the camera to corresponding locations in the display unit.

In example implementations involving touch-based input, the GUI may receive a gesture in the form of a detected tap or swipe of a human finger or stylus on a portion of a touchscreen upon which the canvas region is displayed. Additionally, or alternatively, the gesture may be received as a tap or swipe on another touch-aware surface corresponding to the display screen upon which the canvas region is displayed (e.g., a touchpad having Cartesian coordinates mapped to corresponding coordinates of the display screen, or more particularly, of the canvas region displayed thereon). Still additionally, or alternatively, in some embodiments, the gesture includes a click, click-and-drag, etc. from a mouse or another peripheral operatively connected to the user device. In any case, in response to receiving each of one or more gestures, the interactive GUI may display the one or more gestures in the canvas region (e.g., as dots, lines, or arcs corresponding to the received gesture(s)). One or more received gestures may form a shape, such as an oval, rectangle, triangle, combination of lines, etc.

In other implementations involving camera-based input, the user need not physical touch any particular user input device to provide gestures to the gesture recognition algorithm. Rather, the user may be positioned within any field of view of one or more motion-aware camera devices (e.g., any suitable camera(s) within the user device or otherwise operatively connected to the user device). While positioned within the field of view, the user “draws” gestures in the form of coordinated motions such as points, hand swipes, etc. Effectively, in these scenarios, a gesture input region may comprise any space in the field of view of the one or more camera devices. Receiving gestures at the user device via the one or more cameras may include providing detected motion/camera data as input to one or more motion recognition algorithms, e.g., implemented at the user device and/or at one or more servers, to identify a line or shape corresponding to the detected motion(s). Combinations of forms of input may be utilized, in various embodiments. For example, a user may provide one or more gestures via motions detected via one or more cameras, and subsequently configure at least a portion of the process display via further touch or mouse interactions (e.g., the user may place, rotate, reshape or otherwise configure a line or shape placed in the process display based upon the gestures(s) provided via motion input).

In any case, display creation application includes a memory storing a library of process template objects (“templates”), each of which are representative of a particular entity associated with a process plant. Such process entities can include field devices (e.g., valves, valve positioners, actuators, sensors, etc.), other process equipment (e.g., tanks, reactors, inlets, outlets, process fluid flow lines, etc.), status indicators, alarms, process data communication entities (e.g., workstations, network devices, data storage devices, data communication lines, etc.), and/or various other physical or logical entities, including those mentioned in this detailed description. Each template object has default and modifiable properties associated therewith such that, when an instance of a given template object is placed in the canvas region, properties of the placed instance of the template object can be set to correspond to a particular entity in a process control system or process module to be represented by the process display. Template objects can be configured to have method, animations, event handler behaviors, and other properties associated therewith, effectively allowing the templates to serve as building blocks for process displays to serve the needs of process plant personnel. The user can interconnect the template object instances in the canvas (e.g., interconnecting process fluid flow lines and/or data communication line templates) in a manner that models the real-world relationships among process entities in the process control system or module to be displayed.

Upon receiving one or more gestures forming one or more lines and/or shapes, the display creation application implements the gesture recognition algorithm to identify one or more process entities (and hence, corresponding process template objects) based upon the received one or more gestures (i.e., corresponding to what the user of the display creation application intended to draw or represent). In embodiments, upon identifying a particular process entity based upon the received one or more gestures, the GUI of the display creation application automatically displays, in the canvas region, an instance of the corresponding template object, or alternatively, displays means for selecting the identified process entity to cause the template object instance to be displayed (e.g., the GUI provides a menu allowing the user to select from among one or more identified process entities). As one example, when the user draws one or more gestures forming a straight, bent, or curved line, the gesture recognition algorithm may identify the line as corresponding to a process fluid line, which has a corresponding template object. As another example, when the user draws an oblong shape, the gesture recognition algorithm may identify the oblong shape as corresponding to a process vessel (e.g., a process material storage vessel, a mixing vessel, etc.) that likewise has a corresponding template object. In any case, upon a template object instance being displayed in the canvas region, the user can move, resize, reconfigure, and/or otherwise customize the properties of the template object instance to visually represent the process entity (e.g. via touchscreen GUI interactions and/or other forms of input).

Computing techniques for developing and implementing the gesture recognition algorithm are described herein. In some embodiments, the gesture recognition algorithm is trained to extract shapes, lines, and/or other features from drawn gestures (e.g., from gestures drawn in the GUI canvas region and/or from motion input translated into shapes/lines). The gesture recognition algorithm may, for example, include one or more machine learning models that are trained to identify process entities and their corresponding process templates (output) based at least upon gestures drawn by the user (input). One or more machines may train the machine learning model(s) based upon labeled training data (e.g., combinations of gestures known to correspond to respective process entities). In embodiments, the machine learning model(s) include an artificial neural network. In some embodiments, the user defines new associations between gestures and process entities, and the machine learning model is automatically adapted in response to the new associations. Additionally, in some embodiments, adaptation of the machine learning model is performed responsive to user interactions indicative of whether process identities were correctly identified based upon user input.

Once the user has created a process display, the display creation application can upload the process display to one or more servers, and/or distribute the process display to other devices in the process plant (e.g., for viewing and execution of the display at field devices, workstations, etc. during on-line operation of the process plant).

The display creation application described herein, generally speaking, includes one or more routines each including non-transitory machine-readable instructions stored via one or more non-transitory computer memories and executed via one or more processors of the user device. The one or more routines may include, for example, an interface routine configured to cause the user device to execute the interactive GUI(s) described herein. One or more routines of the display creation application may further include a gesture recognition routine configured to implement the gesture recognition algorithm as described herein. Still additionally, the one or more routines of the display creation application may include a compiler routine that converts a process display into a software format suitable for distribution to and execution at one or more workstations and/or other devices associated with the process environment.

As described herein, components “included” within a user device may include fixed components of the user device at which the display creation application executes, peripheral components wired or wirelessly connected to the user device at which the display creation application executes, or both. For example, functionalities described herein may be performed via a native touchscreen or touchpad, a peripheral touchscreen or touchpad, a mouse, keyboard, and/or suitable input/output (I/O) devices, as will be understood from the disclosure. In some embodiments, the display creation application is implemented at the user device via cloud computing techniques. For example, in some embodiments, gesture recognition operations of the display creation application are performed at one or more remote computers and made available to the user device. As another example, the described library of process template objects is provided at one or more remote computing devices (e.g., servers) communicatively connected to the user device, thereby allowing the user device access to the template objects during operation of the display creation application.

As described herein, the terms “drawn gestures,” “drawn shapes,” “drawn lines,” and the like may refer to user input provided in a canvas region of one or more GUIs as described herein (e.g., via touchscreen swipes, clicking and dragging a mouse, and/or other suitable forms of user input described herein). Additionally, or alternatively, though, the terms “drawn gestures,” “drawn shapes,” “drawn lines,” and the like may refer to motion input detected via one or more cameras, where a motion of a body part of a user forms a line or shape (e.g., movement of a hand horizontally across a field of view of a camera draws a horizontal line, or a circular or ovular movement or a hand or finger draws a circular or ovular shape). Where example gestures, lines, and shapes are described herein with respect to touch or other input into the canvas region of one or more GUIs, corresponding implementations may be envisioned where similar input is provided in the form of motions detected via one or more motion-aware cameras (e.g., within a user device or otherwise operatively connected to the user device).

In some embodiments, one or more tangible, non-transitory computer readable media are provided. The one or more tangible, non-transitory computer readable media store machine-readable instructions that, when executed by one or more processors of a user device, cause the user device to (1) receive one or more gestures forming at least one line or shape in a gesture input region, the one or more gestures being provided by a user, (2) provide the one or more gestures as one or more inputs to a gesture recognition algorithm to identify, based at least upon the received one or more gestures, a process entity represented by the received one or more gestures, the process entity being identified from among a plurality of process entities having respective template objects associated therewith, and (3) based upon the identification of the process entity, display, in a canvas region of a graphical user interface (GUI) executing via the user device, of an instance of a template object corresponding to the identified process entity, the template object being configured to provide a visual representation of operation of the identified process entity in a process plant to thereby form at least a portion of a process display.

In some embodiments, receiving the one or more gestures comprises detecting the one or more gestures via one or more cameras associated with the user device. In these embodiments, receiving one or more gestures may further comprise identifying the one or more gestures by supplying captured motion data from the one or more cameras to one or more gesture recognition algorithms. Additionally, or alternatively, the gesture input region via which one or more gestures are received may be the canvas region of the GUI, e.g. with the one or more gestures being received via one or more touch interactions corresponding to the canvas region.

In some embodiments, the canvas region is displayed via a touchscreen display of the user device, and the one or more gestures are received via one or more touch interactions at the touchscreen display. In other embodiments, the canvas region is displayed via a visual display of the user device, and the one or more gestures are received via one or more touch interactions at a touch-aware surface separate from the visual display. In these embodiments, receiving the one or more gestures includes mapping a location of the one or more touch interactions at the touch-aware surface to a corresponding location of the visual display.

In some embodiments, the instructions, when executed by the one or more processors, further cause the user device to display the at least one line or shape in the canvas region of the GUI upon receiving the one or more gestures. In other embodiments, the user device causes display of an icon selectable to cause the one or more gestures to be provided to the gesture recognition algorithm, and the providing of the one or more gestures to the gesture recognition algorithm is performed responsive to receiving a selection of the icon via the GUI.

In some embodiments, the instructions to provide the one or more gestures to the gesture recognition algorithm include instructions to (1) transmit an indication of the one or more gestures over a network to one or more servers, the one or more servers being configured to implement the gesture recognition algorithm, and (2) receive, from the server over the network, an indication of the identified process entity. In other embodiments, the gesture recognition algorithm is implemented at the user device alone using non-transitory instructions included at the memory of the user device.

In some embodiments, the user device causes display in the GUI of a visual element indicating the process identity being identified via the gesture recognition algorithm, and the displaying of the instance of the template object in the canvas region is performed responsive to receiving a selection of the visual element by the user via the GUI. In some embodiments, identifying the process identity includes (1) obtaining, via the gesture recognition algorithm, an indication of two or more candidate process entities, (2) displaying, via the GUI, a menu indicating the two or more candidate process entities, (3) receiving, from the user via the menu, a selection of a particular process entity from among the two or more candidate process entities, and (4) identifying the selected process entity as the process entity represented by the one or more gestures. In some embodiments, the user device causes the gesture recognition algorithm to be adapted based upon the selection of the particular process entity from among the two or more candidate process entities.

In some embodiments, the identification of the process entity by the gesture recognition algorithm is further based upon a location in the canvas region at which the one or more gestures were received, with respect to locations of one or more other template object instances in the canvas region.

In some embodiments, displaying the instance of the template object in the canvas region includes automatically adjusting a size or location of the instance of the template object in the canvas region. For example, automatically adjusting the size or location may include snapping an edge of the instance of the template object to at least one other template object instance in the canvas region.

In some embodiments, the user device further causes display of a configuration region of the GUI, and receive, via the configuration region of the GUI, a plurality of user interactions to associate the process display with process entities included at least a portion of the process plant, to facilitate operation of the process display using on-line process data from the at least the portion of the process plant.

In some embodiments, the user device further causes upload of the process display to one or more servers. Additionally, or alternatively, in some embodiments, the user device may further cause download of the process display to one or more other devices for viewing of the process display at the one or more other devices during on-line operation of the process plant.

In some embodiments, the user device further defines, based upon one or more user interactions received via the GUI, a new association between one or more user-defined lines or shapes and a particular process entity having a corresponding template. The user device may further cause the gesture recognition algorithm to be adapted to recognize the one or more user-defined lines or shapes as corresponding to the particular process entity.

In some embodiments, the user device modifies one or more properties of the displayed instance of the template object in response to one or more further user interactions received via the GUI. The one or more properties may include an animation, a method, a parameter, a name, a tag, an event handler behavior, and/or a size, shape, or other physical dimension.

In another embodiment, a computer-implemented method is provided. The method includes (1) receiving, via the one or more processors, forming at least one line or shape in a gesture input region, the one or more gestures being provided by a user, (2) via the one or more processors, providing the one or more gestures as one or more inputs to a gesture recognition algorithm to identify, based at least upon the received one or more gestures, a process entity represented by the received one or more gestures, the process entity being identified from among a plurality of process entities having respective template objects associated therewith, and (3) based upon the identification of the process entity, display, via the one or more processors, in the canvas region of a graphical user interface (GUI) executing at a user device, an instance of a template object corresponding to the identified process entity, the template object being configured to provide a visual representation of operation of the identified process entity in a process plant to thereby form at least a portion of a process display.

In still another embodiment, a user device is provided. The user device includes one or more processors, a display, and one or more non-transitory computer memories. The one or more non-transitory computer memories store machine-readable instructions that, when executed by the one or more processors, cause the user device to (1) receive one or more gestures forming at least one line or shape in a gesture input region, the one or more gestures being provided by a user, (2) provide the one or more gestures as one or more inputs to a gesture recognition algorithm to identify, based at least upon the received one or more gestures, a process entity represented by the received one or more gestures, the process entity being identified from among a plurality of process entities having respective template objects associated therewith, and (3) based upon the identification of the process entity, display, in a canvas region of a graphical user interface (GUI) executing via the user device, of an instance of a template object corresponding to the identified process entity, the template object being configured to provide a visual representation of operation of the identified process entity in a process plant to thereby form at least a portion of a process display.

### BRIEF DESCRIPTION OF THE DRAWINGS

FIG. 1 is a block diagram of an example process plant environment including one or more workstations that execute a display creation application;

FIG. 2 illustrates a home screen graphical user interface (GUI) of a display creation application;

FIG. 3A illustrates a process display creation GUI of the display creation application, the process display creation GUI including a canvas region;

FIG. 3B illustrates a first one or more received gestures displayed in the canvas region;

FIG. 3C illustrates a menu in the process display creation GUI for converting the first one or more received gestures to a first process template object;

FIG. 3D illustrates the first process template displayed in the canvas region;

FIG. 3E illustrates a second one or more received gestures displayed in the canvas region;

FIG. 3F illustrates a menu in the process display creation GUI for converting the second one or more received gestures to a second process template object;

FIG. 3G illustrates the second process template displayed in the canvas region;

FIG. 3H illustrates a third one or more received gestures displayed in the canvas region;

FIG. 3I illustrates a menu in the process display creation GUI for converting the third one or more received gestures to a third process template object;

FIG. 3J illustrates the third process template displayed in the canvas region;

FIG. 4A illustrates a sketch drawn or otherwise imported into the canvas region of the display creation application;

FIG. 4B illustrates interface elements for converting the sketch to a process display via the display creation application;

FIG. 4C illustrates a process display created in the display creation application based upon the sketch of FIGS. 4A and 4B;

FIG. 5 illustrates a configuration interface for associating a created process display with a process plant module;

FIG. 6 illustrates an example artificial neural network associated with a gesture recognition algorithm of the display creation application;

FIG. 7 illustrates an example neuron of the artificial neural network of FIG. 6;

FIG. 8 illustrates example conversion of gestures to process template objects via the artificial neural network of FIGS. 6 and 7;

FIG. 9 illustrates a block diagram of an example user device and server;

FIG. 10A illustrates a block diagram of an example computer-implemented method associated with creating a process display;

FIG. 10B illustrates another block diagram of another example computer-implemented method associated with creating a process display;

FIG. 10C illustrates a block diagram of an example computer-implemented method associated with configuring a process display for a process plant module; and

FIG. 10D illustrates a block diagram of still another example computer-implemented method associated with executing a process display at a viewing device.

The figures depict embodiments of the present invention for purposes of illustration only. One skilled in the art will readily recognize from the following discussion that alternate embodiments of the structures and methods illustrated herein may be employed without departing from the principles of the invention described herein.

### DETAILED DESCRIPTION

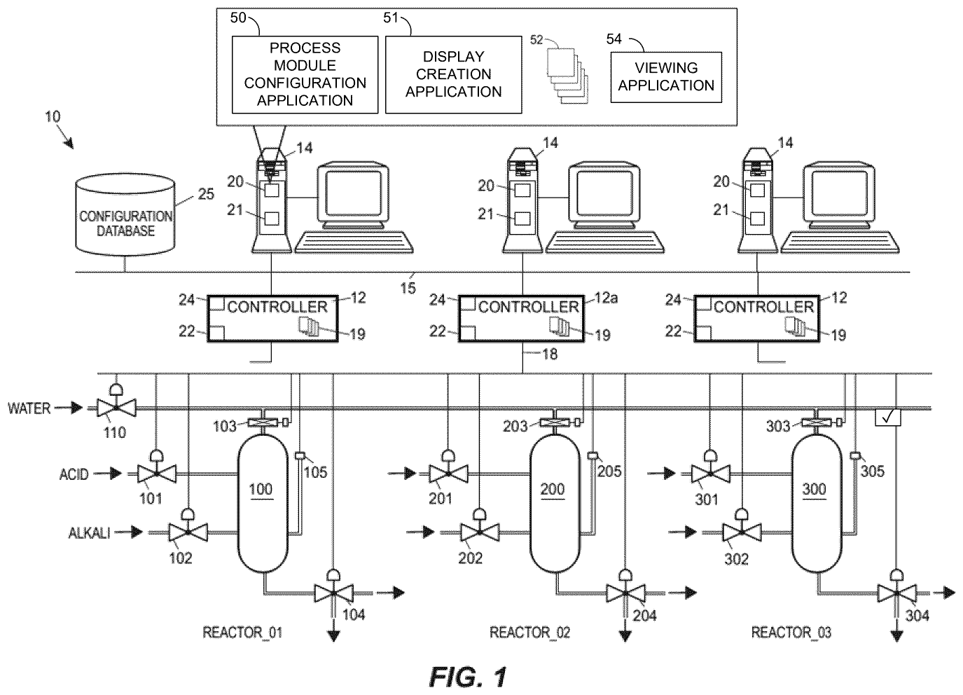

Referring now to FIG. 1, a process plant 10 includes one or more process controllers 12 coupled to numerous workstations 14 via, for example, an Ethernet connection or bus 15. The controllers 12 are also coupled to devices or equipment within the process plant 10 via sets of communication lines or buses 18, with only the set of communication lines 18 connected to the controller 12a being illustrated in FIG. 1. The communication lines or buses 18 may be, for example, wired connections, wireless connections, or a combination of wired and wireless connections. The controllers 12, which may be implemented by way of example only using the DeltaV™ controller sold by Fisher-Rosemount Systems, Inc., are capable of communicating with control elements, such as field devices and function blocks within field devices distributed throughout the process plant 10 to perform one or more process control routines 19 to thereby implement desired control of the process plant 10 or of one or more processes operating in the process plant 10. The workstations 14 (which may be, for example, personal computers) may be used by one or more configuration engineers to design the process control routines 19 to be executed by the controllers 12 and process display routines to be executed by the workstations 14 or other computers, and to communicate with the controllers 12 so as to download such process control routines 19 and process displays to the controllers 12. Furthermore, the workstations 14 may execute display routines that receive and display information pertaining to the process plant 10 or elements thereof during operation of the process plant 10.

Each of the workstations 14 includes a memory 20 for storing applications, such as display or viewing applications, and for storing data, such as configuration data pertaining to the configuration of the process plant 10. Particularly, applications stored at the workstations 14 include a process module configuration application 50 for creating and/or changing process control modules, a display creation application 51 for creating and/or modifying process displays, and a viewing application 54 for viewing process displays and/or other information associated with operation of the process plant 10. Each of the workstations 14 includes a processor 21 that executes the stored applications to enable a configuration engineer to design process control routines, process display routines and other routines and to download these routines to the controllers 12 or to other computers or to collect and display information to a user during operation of the process plant 10. In some embodiments, one or more remote computing devices (e.g., servers) are in communicative connection with the workstations 14 (e.g., via a network or web-based interface) so that a configuration engineer may execute applications remotely from the workstations 14. Furthermore, workstations 14 executing the applications 50, 51, and/or 54 may be substituted with portable computing devices (e.g., tablets, smartphones, etc.), in some embodiments. Each of the applications 50, 51, and 54 may operate at least in part via communication with one or more servers which may, for example, facilitate access by the applications 50, 51, and/or 54 to a configuration database 25 and/or to other information or services involved in operation of the respective applications (e.g., to reference user credential information used to grant/deny privileges to a user of the respective applications).

Still further, each of the controllers 12 includes a memory 22 that stores one or more control and/or communication applications, and a processor 24 that executes the control and/or communication application(s) in any known manner. In one case, each of the controllers 12 stores and executes a controller application that implements a control strategy using a number of different, independently executed, control modules or blocks 19. The control modules 19 may each be made up of what are commonly referred to as function blocks, wherein each function block is a part or a subroutine of an overall control routine and operates in conjunction with other function blocks (via communications called links) to implement process control loops within the process plant 10, e.g., to control the operation of one or more processes performed by the process plant 10.

As is well known, function blocks, which may be objects in an object-oriented programming protocol, typically perform one of an input function, such as that associated with a field device such as a transmitter, a sensor or other process parameter measurement device; a control function, such as that associated with a control routine that performs PID, fuzzy logic, etc. control, or an output function which controls the operation of some device, such as a valve or other field device, to perform some physical function within the process plant 10. Of course, hybrid and other types of complex function blocks exist, such as model predictive controllers (MPCs), optimizers, etc. While the Fieldbus protocol and the DeltaV system protocol use control modules and function blocks designed and implemented in an object-oriented programming protocol, the control modules could be designed using any desired control programming scheme including, for example, sequential function chart, ladder logic, etc. and are not limited to being designed using function block or any other particular programming technique.

The workstations 14 may provide a graphical depiction of the process control routines 19 within the controllers 12 to a user via a display screen illustrating the control elements within the process control routines 19 and the manner in which these control elements are configured to provide control of the process plant 10. In the system of FIG. 1, the configuration database 25 is connected to the Ethernet bus 15 to store configuration data used by the controllers 12 and the workstations 14 and, in some cases, to serve as a data historian by collecting and storing data generated in the process plant 10 for future use. In embodiment, the configuration database 25 includes library items (e.g., templates and class modules) and/or system configuration items (e.g., objects created from library items) corresponding to the configuration data. As such, the configuration database 25 may be logically and/or physically partitioned into a library data storage area and a system configuration storage area.

In the process plant 10 illustrated in FIG. 1, the controller 12a is communicatively connected via the bus 18 to three sets of similarly configured reactors (which are replicated equipment within the plant 10) referred to herein as Reactor_01, Reactor_02 and Reactor_03. Reactor_01 includes a reactor vessel or tank 100, three input valve systems (which are equipment entities) 101, 102 and 103 connected so as to control fluid inlet lines providing acid, alkali and water, respectively, into the reactor vessel or tank 100 and an outlet valve system 104 connected so as to control fluid flow out of the reactor vessel or tank 100. A sensor 105, which can be any desired type of sensor, such as a level sensor, a temperature sensor, a pressure sensor, etc., is disposed in or near the reactor vessel or tank 100. For the purpose of this discussion, the sensor 105 is assumed to be a level sensor. Moreover, a shared header valve system 110 is connected on the water line upstream of each of the reactors Reactor_01, Reactor_02 and Reactor_03 to provide a master control for controlling the flow of water to each of those reactors.

Similarly, Reactor_02 includes a reactor vessel or tank 200, three input valve systems 201, 202 and 203, an outlet valve system 204 and a level sensor 205 while Reactor_03 includes a reactor vessel or tank 300, three input valve systems 301, 302 and 303, an outlet valve system 304 and a level sensor 305. In the example of FIG. 1, the reactors Reactor_01, Reactor_02 and Reactor_03 may produce salt with the input valve systems 101, 201 and 301 providing acid, the input valve systems 102, 202 and 302 providing alkali and the input valve systems 103, 203 and 303, in conjunction with the shared water header 110, providing water to the reactor vessel or tank 100. The outlet valve systems 104, 204 and 304 may be operated to send product out of a flow line directed to the right in FIG. 1 and to drain waste or other unwanted material out of a flow line directed to the bottom in FIG. 1.

The controller 12a is communicatively coupled to the valve systems 101-104, 110, 201-204 and 301-304 and to the sensors 105, 205 and 305 via the bus 18 to control the operation of these elements to perform one or more operations with respect to the reactor units, Reactor-01, Reactor_02 and Reactor_03. Such operations, generally called phases, may include, for example, filling the reactor vessels or tanks 100, 200, 300, heating the material within the reactor vessels or tanks 100, 200, 300, dumping the reactor vessels or tanks 100, 200, 300, cleaning the reactor vessels or tanks 100, 200, 300, etc.

The valves, sensors and other equipment illustrated in FIG. 1 may be any desired kinds or types of equipment including, for example, Fieldbus devices, standard 4-20 ma devices, HART devices, wireless HART devices, etc. and may communicate with the controller 12 (e.g., any of the controllers 12 or 12a) using any known or desired communication protocol such as the Fieldbus protocol, the HART protocol, a wireless HART protocol or other wireless protocol, the 4-20 ma analog protocol, etc. Generally, devices that are located within the process environment and that perform a function directly impacting the control of the process (e.g., a physical function such as opening or closing valves, a measurement function to be used in a control algorithm or loop, and/or other function) are referred to herein as “field devices.”

Still further, other types of devices may be connected to and be controlled by the controllers 12 in accordance with the principles discussed herein. For example, a controller 12 may be connected to one or more input/output (I/O) devices (not shown) which, in turn, may be connected to one or more field devices. An I/O device typically is used by a controller 12 to enable communications between the one or more field devices, the controller 12, and/or the process control system. As such, the I/O device may also be a participant in the direct execution of a control algorithm or loop to control a process. Accordingly, controllers, I/O devices, and field devices are generally and categorically referred to herein as “process control devices.” Of course, the term “process control device” is not limited to only controllers, I/O devices and field devices, but may also include other devices that participate in or are required for control algorithms and/or loops to be executed to control a process in a process plant or process control system.

Additionally, other numbers and types of controllers may be connected within the plant 10 to control other devices or areas associated with the process plant 10 and the operation of such additional controllers may be coordinated with the operation of the controller 12a illustrated in FIG. 1 in any desired manner. In some embodiments, the process plant 10 of FIG. 1 includes one or more nodes for wireless communications (not shown) within the process plant 10, such as access points, gateways between wireless and wired networks within the plant 10, gateways to other networks, repeaters, routers, etc. within or external to the plant 10, and the like. These nodes for wireless communications may be communicatively coupled (using a wired protocol, a wireless protocol, or a combination thereof) to controllers 12, workstations 14, the configuration database 25, field devices, other wireless-enabled nodes, and other databases or data storage devices. In some embodiments, portable devices of process plant personnel (e.g., engineers, operators, maintenance personnel, etc.) executing the display creation application described herein may utilize the one or more wireless communication nodes to communicate over one or more plant networks to create, download, and/or distribute one or more process displays for use in the process plant 10.

Generally speaking, the process plant 10 of FIG. 1 may be used to implement batch processes in which, for example, one of the workstations 14 or the controller 12a executes a batch executive routine, which is a high level control routine that directs the operation of one or more of the reactor units (as well as other equipment) to perform a series of different steps (commonly referred to as phases) needed to produce a product, such as a particular type of salt. To implement different phases, the batch executive routine uses what is commonly referred to as a recipe which specifies the steps to be performed, the amounts and times associated with the steps and the order of the steps. Steps for one recipe might include, for example, filling a reactor vessel with the appropriate materials or ingredients, mixing the materials within the reactor vessel, heating the materials within the reactor vessel to a certain temperature for a certain amount of time, emptying the reactor vessel and then cleaning the reactor vessel to prepare for the next batch run. Each of the steps defines a phase of the batch run and the batch executive routine within the controller 12a will execute a different control algorithm for each one of these phases. Of course, the specific materials, amounts of materials, heating temperatures, times, etc. may be different for different recipes and, consequently, these parameters may change from batch run to batch run depending on the product being manufactured or produced and the recipe being used. Those skilled in the art will understand that, while control routines and configurations are described herein for batch runs in the reactors illustrated in FIG. 1, control routines may be used to control other desired devices to perform any other desired batch process runs or to perform continuous process runs, if so desired.

Generally speaking, the display creation application 51 described herein is utilized to create and/or distribute process displays for use in the process plant 10, the process displays being configured to visually represent aspects of operation of the process plant 10, including during execution of the process. Process displays created using the display creation application 51 may be constructed from a library of preconfigured template objects 52 representative of respective process entities. In some embodiments, the library of template objects 52 may be stored at the configuration database 25 and/or other storage devices in the process plant for access by the display creation application 51 executing at workstations 14. In any case, downloading and executing process displays at workstations, controllers, field devices, etc. may allow plant personnel to easily view operating parameters and/or other information associated with entities in the process plant 10 during on-line operation of the process.

As an example with respect to the process plant 10 of FIG. 1, a first process display associated with Reactor_01 may be configured to display operational information associated with two or more entities within Reactor_01 (e.g., a current and/or historical temperature of material contained within the vessel 100, a temperature or flow rate of process material through input valve systems 101, 102, 103, a reading of the level sensor 105, warnings or alarms associated with potential damage to process equipment or other hazardous conditions within the process plant 10, etc.). The first process display may, for example, be downloaded to and executed at a workstation 14 during execution of the process, such that a user of the workstation 14 may view information associated with Reactor_01 during operation of a process involving Reactor_01. Additionally, or alternatively, the same process display may be downloaded to and executed at a portable device (e.g., smartphone, tablet, smart wearable, etc.) of an operator walking about the area of the process plant 10 at or near which Reactor_01 is located, thereby enabling the operator to view and respond to operational information regarding the area of the process plant 10 at which the operator is located. A second example process display for the process plant 10 may be configured to display operational information related more specifically to the vessel 10 (e.g., current and/or historical operating parameters of the vessel 100, status of inlets/outlets connected to the vessel 100, etc.). The second process display may, for example, be downloaded to and executed at the vessel 10 itself (e.g., at the vessel 100 having smart capabilities, or at a smart device operatively coupled to the vessel 100), such that operational information associated with the vessel 100 may be displayed at or near the vessel 100 itself during execution of the process. Numerous other examples are possible, and it should be understood that the configuration of process displays will vary based upon the arrangement of entities within the process plant (or portion thereof) to which the process displays respectively pertain.

Examples of interactive graphical user interfaces (GUIs) associated with the display creation application 51 will be described with respect to subsequent figures. The GUIs of the display application may be presented, for example, at desktop workstations 14, portable electronic devices (e.g., smartphones, tablets, laptop computers, etc.), and/or other suitable user devices executing the display creation application. While executing the display creation application, the user device may be communicatively connected to one or more servers, which may for example perform back-end processing associated with creation of displays. The one or more servers may, for example, execute one or more gesture recognition algorithms and/or one or more motion recognition algorithms as described herein. Aspects of the described GUIs may be substituted, rearranged, and/or combined, in various embodiments. Where input to the described GUIs is described as being implemented via touchscreen interactions, it should be appreciated that other forms of gesture input may be possible (e.g., mouse interactions, motions detected via one or more motion-aware cameras, etc.).

### Example Graphical User Interfaces of a Display Creation Application

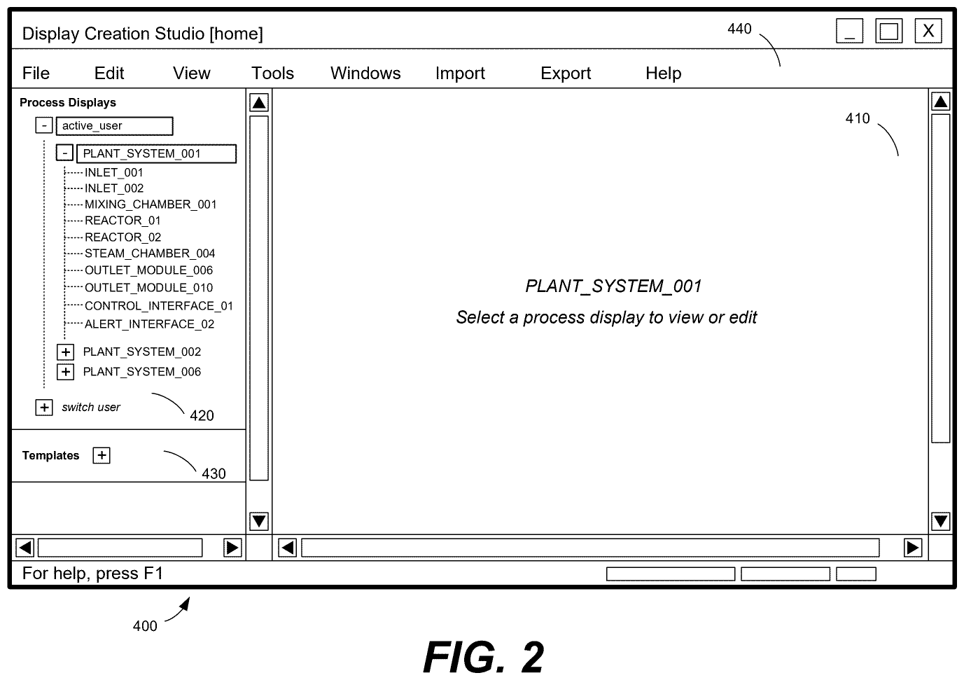

Turning to FIG. 2, an interactive GUI 400 of a display creation application (“Display Creation Studio”) for creating, modifying, and/or distributing process displays is illustrated (e.g., the display creation application 51 of FIG. 1). Particularly, the GUI 400 provides a home interface facilitating operations of the display creation application including creation of new process displays, modification of existing process displays, and/or distribution of completed process displays among devices in a process plant.

The GUI 400 includes a canvas region 410 usable to place and arrange instances of template objects representative of process entities included in a process display. The user can interact with a process display explorer region 420 to locate and select a particular process display to create and/or modify in the canvas region 410. The user may navigate the process display explorer region 420, for example, via a hierarchical file structure indicating one or more process control systems/modules available to the user and one or more process displays available for each respective process control system/module. In the example GUI 400 of FIG. 2, a particular process display has not yet been selected, and thus the canvas region 410 is empty. The GUI 400 further includes a template explorer region 430 which, although being collapsed in the view of FIG. 2, may be expanded and navigated to discover process template objects available for inclusion in the process display to be assembled in the canvas region 410. The GUI 400 further still further includes a top menu region 440 providing various options and functionalities such as navigating file structures, adjusting views of process displays (e.g., zoom, visual preferences, etc.), copy/paste functionality, and/or importing/exporting process displays to/from other devices in the process plant.

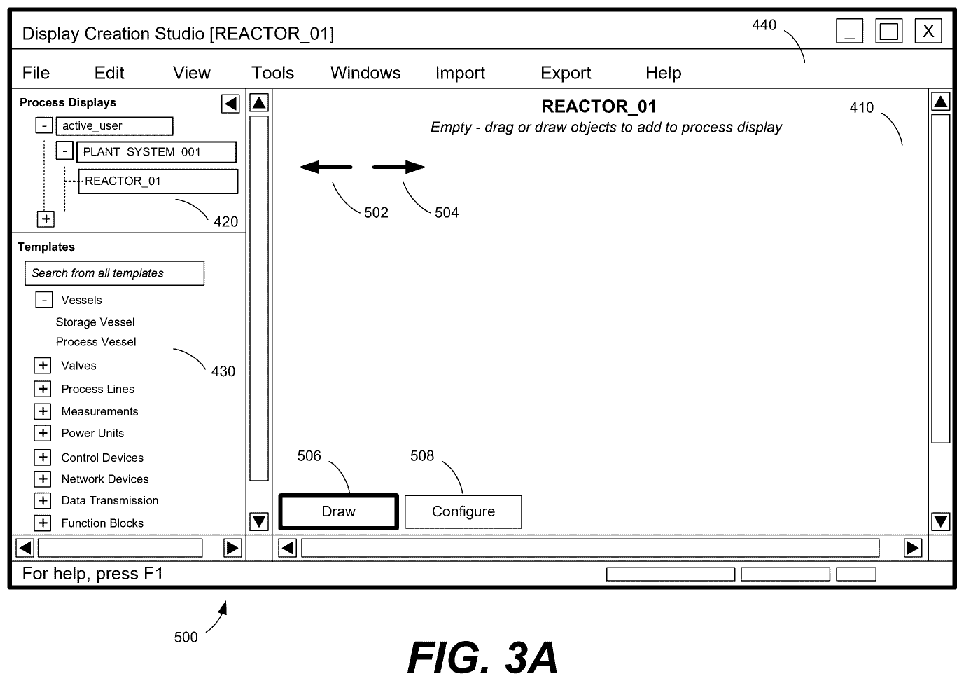

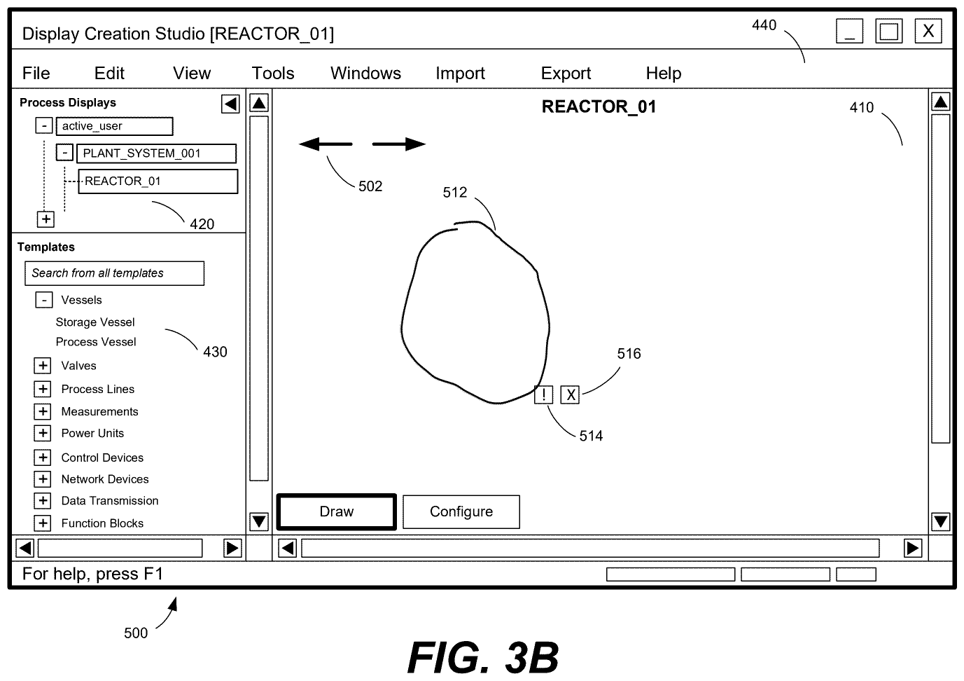

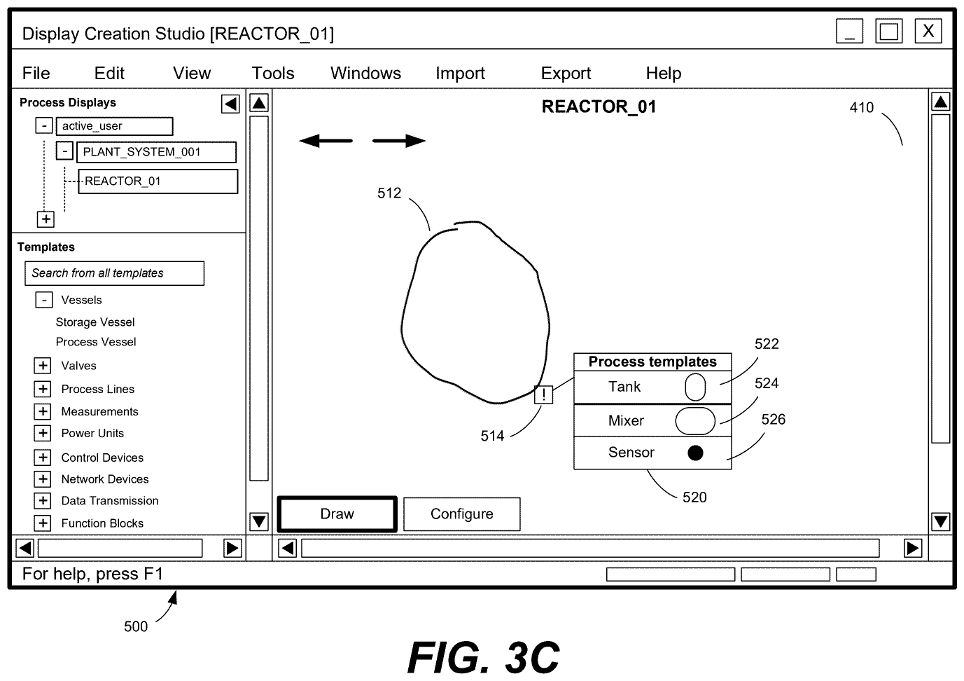

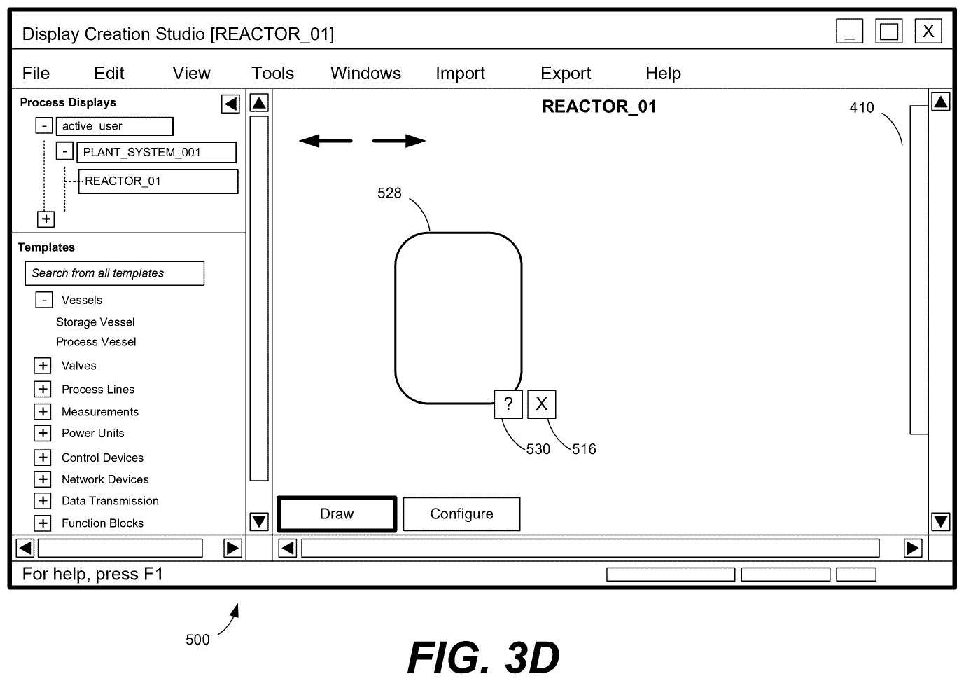

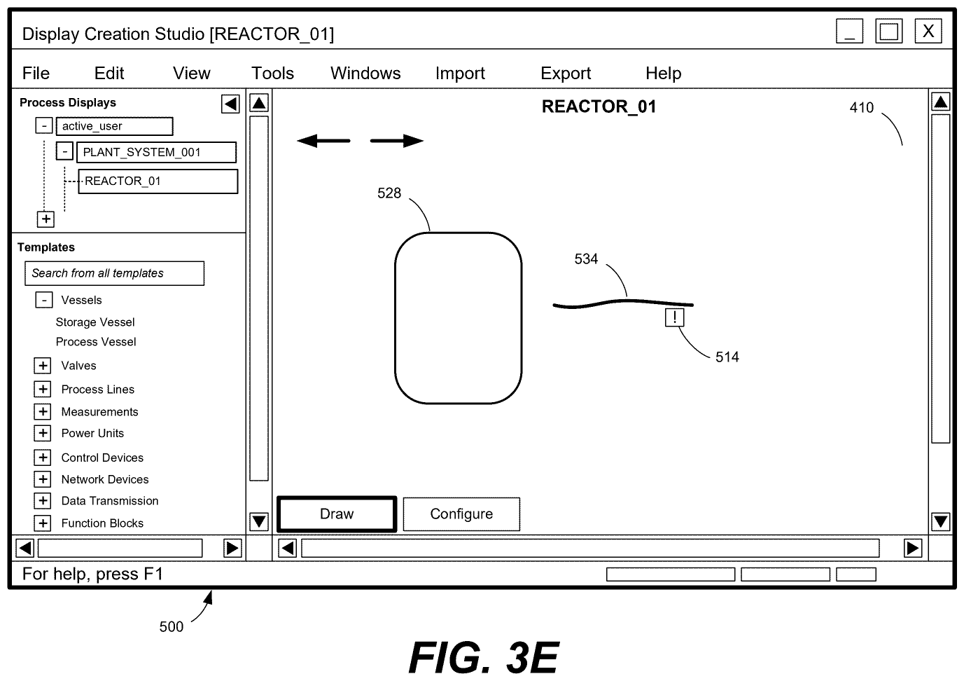

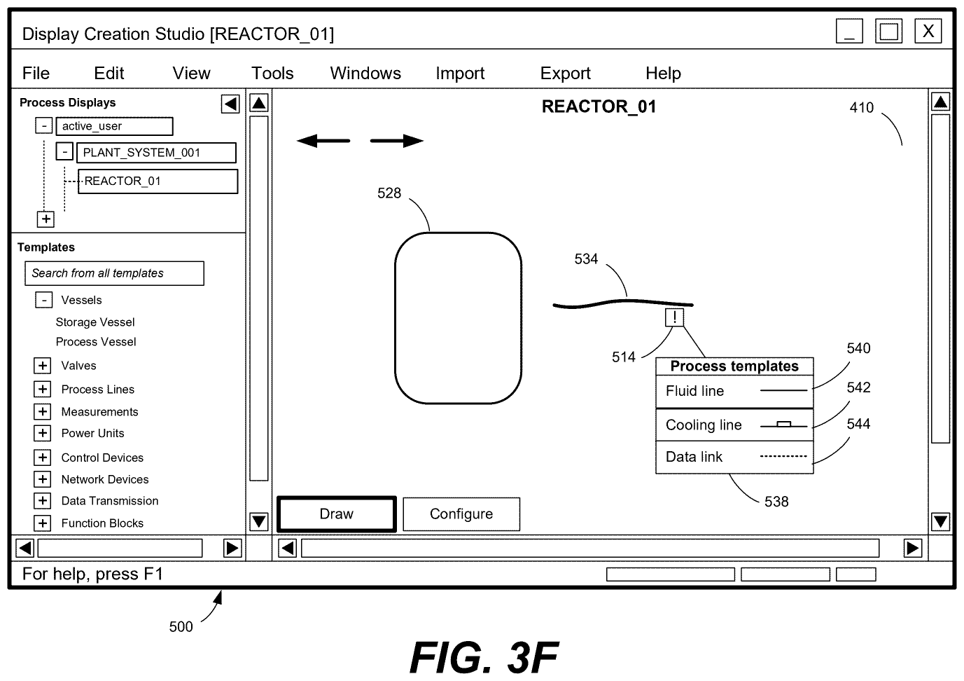

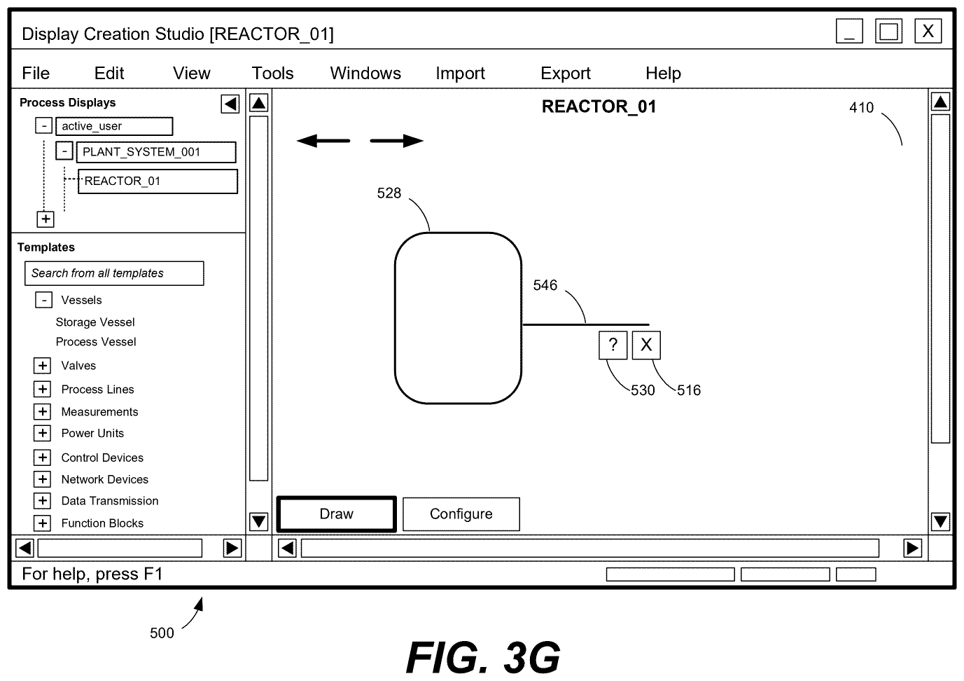

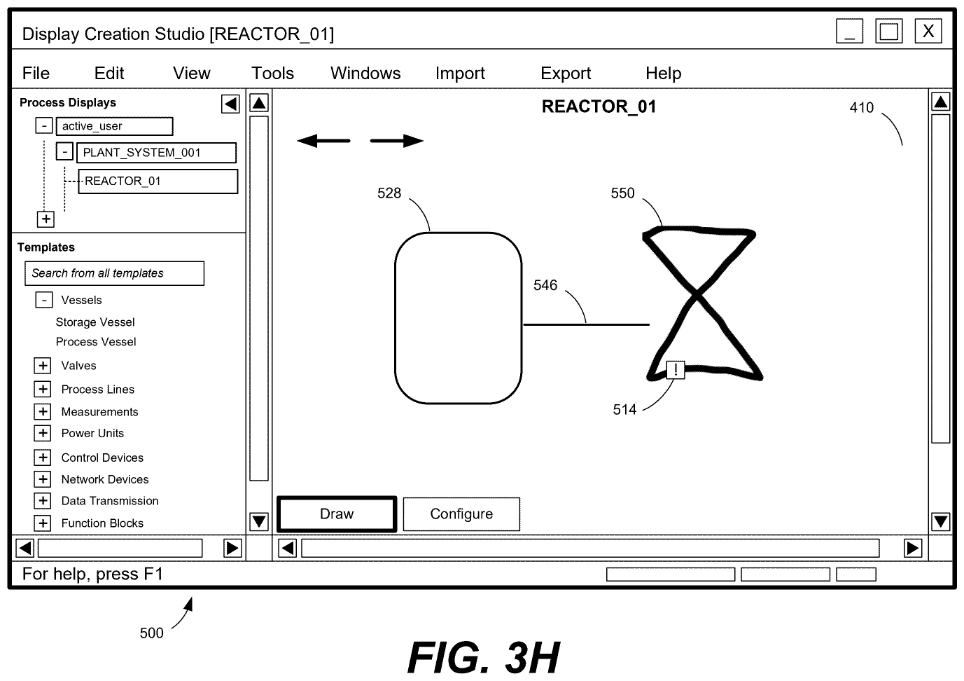

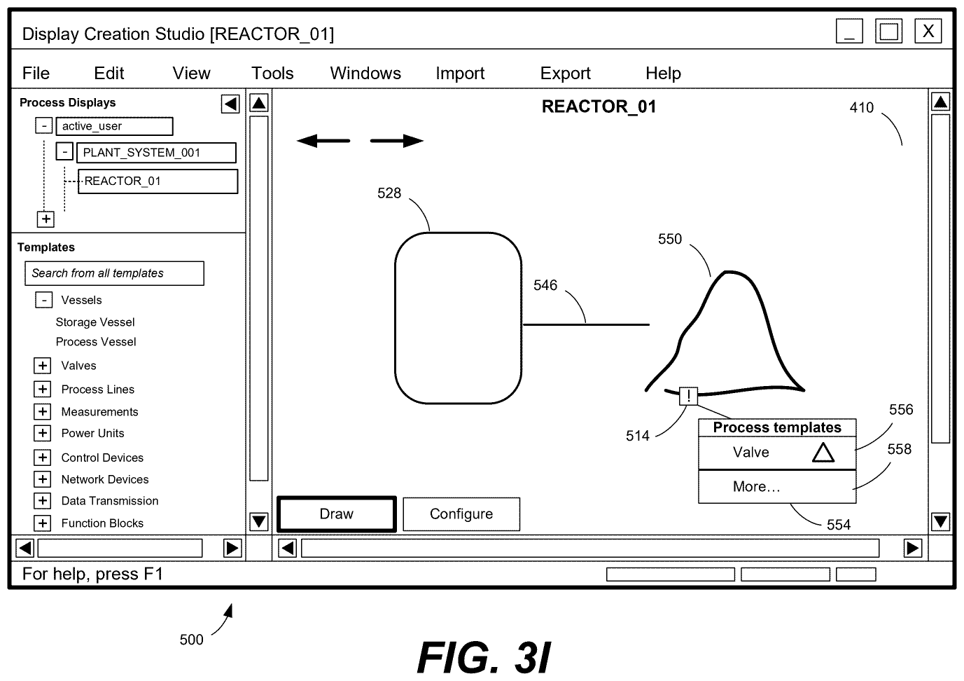

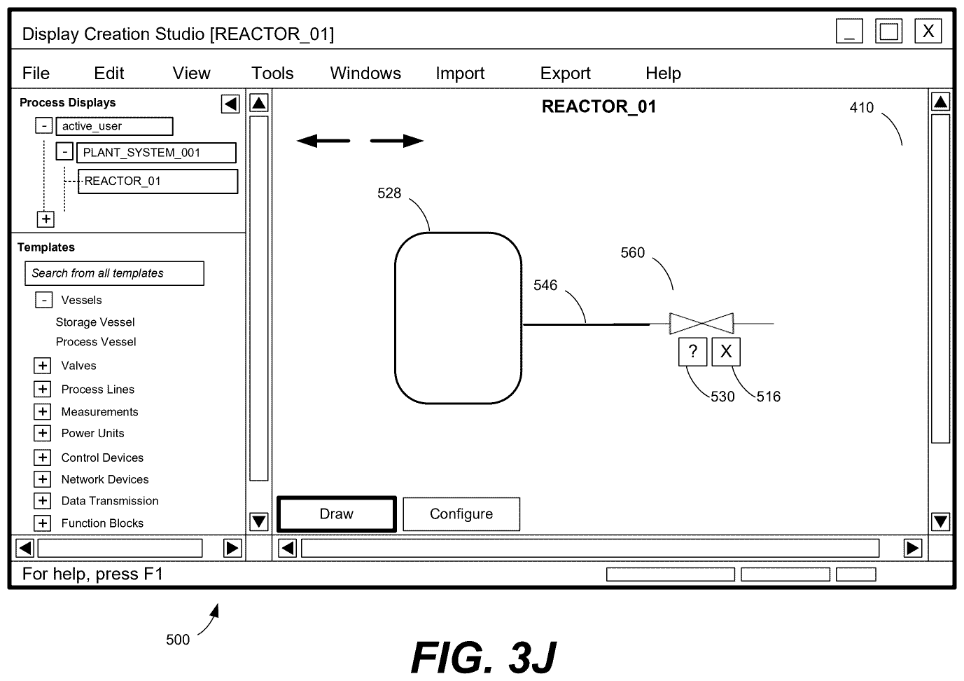

FIG. 3A illustrates an interactive GUI 500 for creating a process display. The GUI 500 as shown in FIG. 3A is similar to the GUI 400 of FIG. 2, e.g., the GUI 500 includes the interface regions 410, 420, 430, and 440. In the GUI 500 of FIG. 3A, though, a particular process display “REACTOR_001” has been selected for editing in the canvas region 410 (e.g., by choosing the display from the process display explorer region 420). Additionally, in the GUI 500, a portion of the template explorer region 430 is expanded to provide a template “search” feature and a hierarchical menu for locating various available template objects. The user may expand/collapse menus and submenus of the template explorer region 430 via “+” and “−” icons adjacent to each expandable or collapsible item.

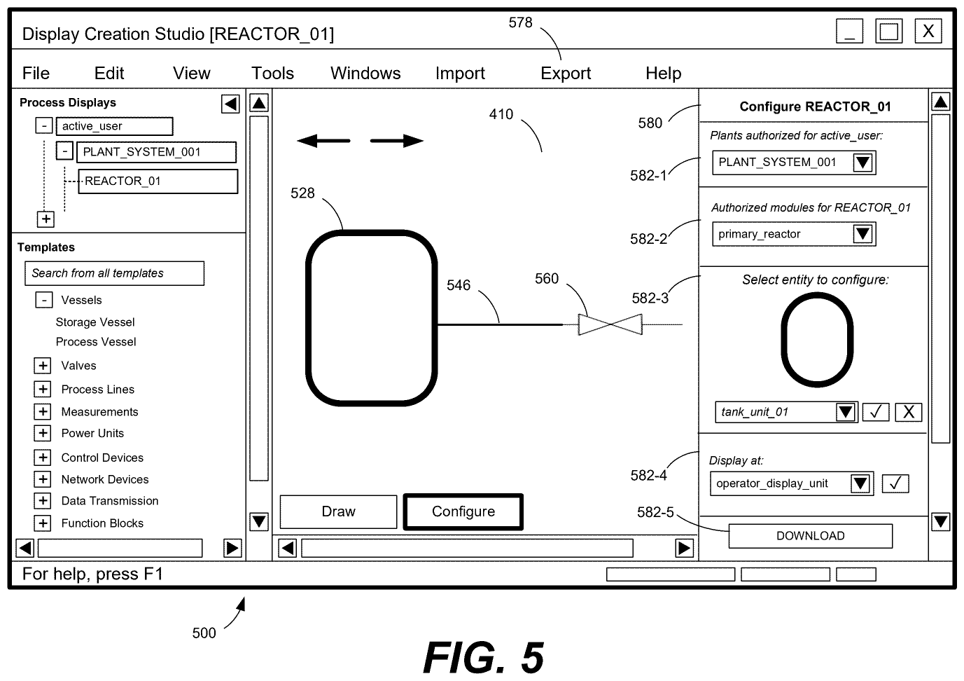

The canvas region 410 includes an “undo” icon 502 to erase a previous operation (e.g., to erase the most recent gesture, selection, or modification made in the GUI 500), and a “redo” icon 504 to reverse a previous use of the “undo” icon 502. The GUI 500 still further includes icons 506 and 508 selectable to switch between two modes of operation of the GUI 500. Namely, selection of the “draw” icon 506 (as shown in FIG. 3A) enables a first “draw” mode that allows the user to draw and select process templates to be included in the process display. Selection of the “configure” icon 508 may enable a second “configuration” mode that enables the user to link process templates in the process display to real entities in the process plant environment, thereby configuring the process display for use in a particular process plant or a particular portion thereof. Access to the configuration mode may be limited based upon user privileges, e.g., to limit configuration access to personnel having knowledge of the process plant or portion thereof that is being represented by the process display. This section of the detailed description will be limited to discussion of the draw mode, whereas further discussion of the configuration mode is provided in this detailed description with respect to FIG. 5.

As shown in the template explorer region 430, various process template objects may be envisioned. The template objects can represent, for example, process vessels (e.g., preprocessing raw material storage vessels, post-processing storage vessels, intermediate process vessels, etc.); valves, process lines (e.g., for transporting process fluids into the process plant, out of the process plant, and/or between entities in the plant), measurement devices (e.g., temperatures sensors, pressure sensors, fluid level sensors, etc.), power units (e.g., generators, transducers, etc.), actuators (e.g., pneumatic actuators, linear actuators, etc.), controller devices; network devices (e.g., routers, modems, etc.), data transmission lines and data storage devices, control function blocks, and/or other suitable physical or logical process plant entities.

In any case, the GUI 500 supports “drag-and-drop” operations via mouse input, touchscreen input, and the like, allowing the user to select a process template from the region 430 (e.g., via a touch or mouse click) and “drag” the selected process template into the canvas region 410 to create a configurable instance of the selected process template in the canvas region 410. For many process plant personnel using the display creation application, though, creating process displays via drag-and-drop operations may be difficult or impractical. For one, some process plant personnel may not be familiar with the template explorer functions and other user interfaces, menus, etc. of the display creation application. Furthermore, when attempting to use the display creation application at devices with small screens and/or by which touch input is used, use of template explorer region 430 may prove particularly difficult. Although dedicating additional screen space of the GUI 500 to the template explorer region 430 might provide for easier navigation of the template explorer region 430, doing so would in turn reduce screen space afforded to other regions including the canvas region 410, thus making the GUI 500 less usable for its foremost purpose of creating/editing process displays.

Gesture recognition techniques of the present description may alleviate at least these difficulties and otherwise improve the user experience of the display creation application by intelligently recognizing gestures drawn by the user, e.g., via touchscreen interaction corresponding to the canvas region 410 and/or via motion-based input. In an example scenario that described with respect to FIGS. 3B-3J, the user may use the interactive GUI 500 to create a process display to represent operation of at least a portion of a reactor system (e.g., to display a portion of Reactor_01 including operational information associated with the tank 100, input valve systems 101, 102, and/or 103, output valve system 104, and/or sensor 105).

Turning to FIG. 3B, the GUI 500 displays a shape 512 drawn by the user, which the user intends to represent a tank for holding a process fluid. The shape 512 may be formed, for example, by one or more lines drawn by the user via (e.g., via touch gestures within the canvas region 410, via motion-based input, and/or another suitable technique). In embodiments, the GUI 500 causes the gesture recognition algorithm to be implemented each time the user provides a new gesture, i.e., to analyze each new user input as it is received. In the scenario of FIG. 3B, responsive to receiving the shape 512, the gesture recognition algorithm determines that the shape 512 is an oval representative of a process entity such as a process fluid tank. In some instances, the gesture recognition algorithm may identify two, three, or more “candidate” process entities that may correspond to the shape 512, but determines that the tank is the most likely process entity being represented by the shape 512.

Multiple approaches are possible for translating the drawn shape 512 into a process template instance to be displayed in the canvas region 410, based upon the output(s) produced by the gesture recognition algorithm. Example implementations of multiple approaches be described below, and it should be understood that still alternate approaches may be envisioned, and further, that multiple approaches may be combined, in various embodiments.

In an embodiment illustrated in FIG. 3B, the GUI 500 displays an icon 514 adjacent to the shape 512, the icon 514 indicating that the gesture recognition algorithm identified one or more process entities based upon by the shape 512. As will be described with respect to subsequent figures, selection of the icon 514 facilitates selection of a template object instance to be placed in the canvas region 410. Selection of an icon 516 (or alternatively, the “undo” icon) may cause the drawn shape 512 or at least the most recently drawn portion thereof to be deleted from the canvas region 410.

Referring now to FIG. 3C, responsive to a selection of the icon 514 by the user (e.g., a touch interaction on or near the icon 514), the GUI 500 displays a menu overlay 520 that lists process template objects corresponding respectively to three candidate process entities identified by the gesture recognition algorithm. In the example scenario shown in FIG. 3C, the menu overlay 520 lists a tank template option 522, a mixer template option 524, and a sensor template option 526. Each of the template options 522, 524, and 526 includes a graphical representation of the corresponding process template. In some scenarios, a template option listed in the menu overlay 520 corresponds to two or more templates, e.g., sensor template o5128

Option 526 may correspond to two or more different sensor templates including a pressure sensor, a temperature sensor, a fluid volume sensor, etc. In these scenarios, selecting the sensor template option 526 causes the GUI 500 to display template options for the two or more different sensor templates, and the user may select a particular sensor template to be provided in the canvas region 410. Effectively, the menu overlay 520 facilitates hierarchical navigation of templates, where appropriate. In scenarios where still other templates are identified as potentially corresponding to the shape 512, the user can enlarge, scroll, and/or otherwise navigate the menu overlay 520 to view the other identified process template(s). In some embodiments, the suggestions of the identified process templates in the menu overlay 520 are ranked based upon output of the gesture recognition algorithm, e.g., the gesture recognition algorithm produces a score for each respective process entity based upon similarity of the shape 512 to the process entity and/or corresponding template, and/or based upon contextual information such as the name of the process display, the position(s) of other template objects in the process display relative to the shape 512, and/or other factors described herein.

As illustrated in FIG. 3D, responsive to a selection of the tank template option 522, the GUI 500 places an instance of the tank template 528 in the canvas region 410 (although “tank template 528” is referred to herein, it should be understood that tank template 528 refers to one instance of the tank template in the canvas region 410). In some embodiments, the GUI 500 automatically resizes or repositions the tank template 528, e.g., to reduce the tank template 528 to a sensible size if the shape 512 of FIG. 3B occupied most of the canvas region 410. The GUI presents a question mark (“?”) icon 530, selection of which enables the user to summon the previously displayed menu overlay 520 of FIG. 3C, e.g., to change the selection of the process template based upon the shape originally drawn by the user. The GUI 500 also present the icon 516, selection of which causes the GUI to delete tank template 528 (and the underlying drawn shape) from the canvas region 410. In some embodiments, the icons 530 and/or 516 may be removed from view in the canvas region 410, and presented only when the user interacts with the GUI 500 near the tank template 528. Still other touch-enabled interactivity may be provided for dimensions the view of the tank template 528 (e.g., touch-based relocation and/or resizing of the tank template 528).

In any case, once the instance of the tank template 528 is placed in the process display in the canvas region 410, the user may modify various properties of tank template 528, e.g. to cause the tank template 528 to be more closely representative of a particular tank in a process control environment in which the user envisions the process display may be implemented. For example, the user may change a name, tag, operational parameter, or event handler behavior associated with the tank template 528, or may interconnect physical or logical inputs and/or outputs of the tank template 528.

The description above with respect to FIGS. 3B, 3C, and 3D represents only some approaches that may be used to translate the drawn shape 512 to the tank template 528. However, numerous other approaches are possible. For example, in some embodiments, responsive to the user selecting the icon 514 in FIG. 3B, the GUI 500 identifies the most likely process template corresponding to the shape 512 (e.g., the “top output” of the gesture recognition algorithm, which in this instance is the tank template 528), and automatically displays the tank template 528 in the canvas region 410 in place of the shape 512. In some embodiments, the GUI 500 automatically causes the menu overlay 520 to be displayed responsive to receiving the shape 512 and executing the gesture recognition algorithm immediately based thereupon. Still alternatively, in some embodiments, the GUI 500 causes the gesture recognition algorithm to be executed and the tank template 528 to be displayed directly responsive to receiving the shape 512 (e.g., immediately after receiving the shape 512, or after a predetermined amount of time has passed since the shape 512 was completed). In any of these embodiments, the GUI 500 may still display the icon 530 on or near the tank template 528 to allow the user to navigate other process templates identified via the gesture recognition algorithm. In some embodiments, the user configures settings of the display creation application to set preferences as to what specific approach is used to translate the drawn shape to the template object, from among the approaches described herein.

Proceeding now to FIG. 3E, after display of the tank template 528, the user draws a line 534 (e.g., via touchscreen interaction in the canvas region 410), which the user intends to represent a fluid output of the tank template 528. The GUI 500 displays another instance of the icon 514 responsive to the gesture recognition algorithm identifying one or more process entities based upon the drawn line 534. Particularly, as illustrated in FIG. 3F, responsive to a selection of the icon 514, the GUI 500 displays a menu overlay 538 listing the process entities (i.e., the corresponding templates) identified based upon the line 534. Accordingly, the menu overlay 538 displays a standard process fluid line template option 540, a process fluid cooling line template option 542, and a data link template option 544. Responsive to selection of the process fluid line template option 540, the GUI 500 places an instance of a fluid line template 546 in the canvas region 410 in place of the line 534, as illustrated in FIG. 3G. The user may subsequently modify names, tags, operational parameters, and/or other properties of the fluid line template 546 (i.e., properties of the placed instance thereof). In some embodiments, dimensions of the fluid line template 546 are adjusted and an end of fluid line template 546 is automatically “snapped” to an edge of the tank template 528. Additionally, or alternatively, the user may “snap” the fluid line template 546 to an edge of the tank template 528 by moving the fluid line template 546 within the canvas region 410, e.g., via touch and drag operations.

As with the placing of the tank template 528 as described with respect to FIGS. 3B-3D, additional and/or alternate approaches are possible for translating the drawn line 534 to the fluid line template 546. For example, in some embodiments, the GUI 500 automatically causes the gesture recognition algorithm to be executed and places the fluid line template 546 responsive to the user drawing the line 534, or responsive to the user selecting the instance of the icon 514 next to the line 534. In some embodiments, the gesture recognition algorithm operates upon the line 534 using contextual information, e.g., using the placement of the line 534 relative to the tank template 528 to determine that the line represents a particular entity that would act as an input or output of the tank template 528. Accordingly, the menu overlay 538 in FIG. 3F may rank the process fluid line template options 540 and/or process fluid cooling line template option 542 above the data link template option 544, or may omit the data link template option 544 from view in the menu overlay 538.

Moving now to FIG. 3H, the user of the display creation application intends to connect a valve to a distal end of the process fluid line 546 in the process display. Accordingly, the user may draw, in the canvas region 410, a shape 550 comprises two oppositely facing triangles connected (or nearly connected) to each other. Responsive to identifying one or more process templates that may correspond to the shape 550, the GUI 500 may display yet another instance of the icon 514 near the shape 550, indicating the identification of the process template(s).

Responsive to selecting the icon 514 in FIG. 3H, the GUI 500 may display another menu overlay 554, as illustrated in FIG. 3I. The menu overlay 554 includes a valve template option 556, based upon an identification of a process valve as being the most likely process template represented by the shape 550. In some embodiments, the identification of the valve template option 556 is context-based, e.g., based upon the placement of the shape 550 near the tank template 528 and fluid line template 546 being associated with higher likelihood that the shape 550 is intended to represent a valve. In the scenario illustrated in FIG. 3I, the GUI 500 determines that the valve template option 556 is the only likely process template represented by the shape 550 (e.g., the only template determined by the gesture recognition algorithm exceeding a threshold score), and thus the valve template option 556 is the only template option immediately included in the menu overlay 554. The menu overlay 554 includes a “More . . . ” option 558 that the user may select to view still other template options that may correspond to the shape 550 (e.g., the next-most likely template(s) identified via the gesture recognition algorithm). Upon receiving a selection of the valve template option 556, the GUI 500 causes an instance of a valve template 560 to be displayed in the canvas region 410, as illustrated in FIG. 3I. The GUI 500 may automatically snap an edge of the valve template 560 to an end of the fluid line template 546, and/or may automatically resizes the valve template 560 to be relatively proportional to the tank template 528 and/or the fluid line template 546. In any case, the user may subsequently modify properties of the valve template 560 (i.e., properties of the placed instance thereof).

As with the placement of the templates 528 and 546 as described with respect to FIGS. 3B-3G, additional and/or alternative approaches may be implemented to translate the shape 550 of FIG. 3H to the valve template 560 of FIG. 3J. For example, in some embodiments, responsive to identifying that the valve template 560 is the only process template exceeding a threshold likelihood of being the template depicted by the shape 550, the GUI 500 may automatically place the valve template 560 in the canvas region in lieu of the shape 550.

In the scenario described with respect to FIGS. 3B-3J, the process display in the canvas region 410 is created by the user drawing each line or shape and converting the line or shape to a respective process template before drawing a next line or shape. However, other use cases are possible. For example, the user of the display creation application might draw a multiplicity of lines/shapes representative of two, three, four or more process entities before providing any interactions to convert the drawn lines/shapes to template objects. Alternatively, in some use cases, the GUI 500 imports hand-drawn or machine-printed drawings into canvas region 410, from which the gesture recognition algorithm operates to produce template objects corresponding to respective process entities depicted therein.

While examples of shapes/lines and corresponding templates have been provided herein, it should be understood that many additional examples are possible. That is, the display creation application may provide for any process entity to have a corresponding process template, and each respective process entity and corresponding template may be mapped to shapes/lines drawn by the user to represent the respective process entity. Moreover, in some embodiments, the display creation application enables the user to create new associations define new gestures as corresponding to a particular process entity, such that the gesture recognition algorithm will recognize subsequent use of the gestures as corresponding to the particular process entity and the corresponding template. For example, the user may choose to define that a rhombus shape, when drawn in the canvas region, corresponds to a particular power generation unit, and a new or existing template object corresponding to the particular power generation unit. As another example, the user may define that a series of three vertical lines positioned horizontally adjacent to each other corresponds to a data historian. In this sense, the gesture recognition algorithm is adaptive to accommodate “out-of-the-box” gestures natively programmed in the display creation application, as well as new gestures defined by the user to accommodate the user's specific tendencies and needs, which may comprise associating easily produced gestures with a desired process entity.

### Example Process Display Conversion

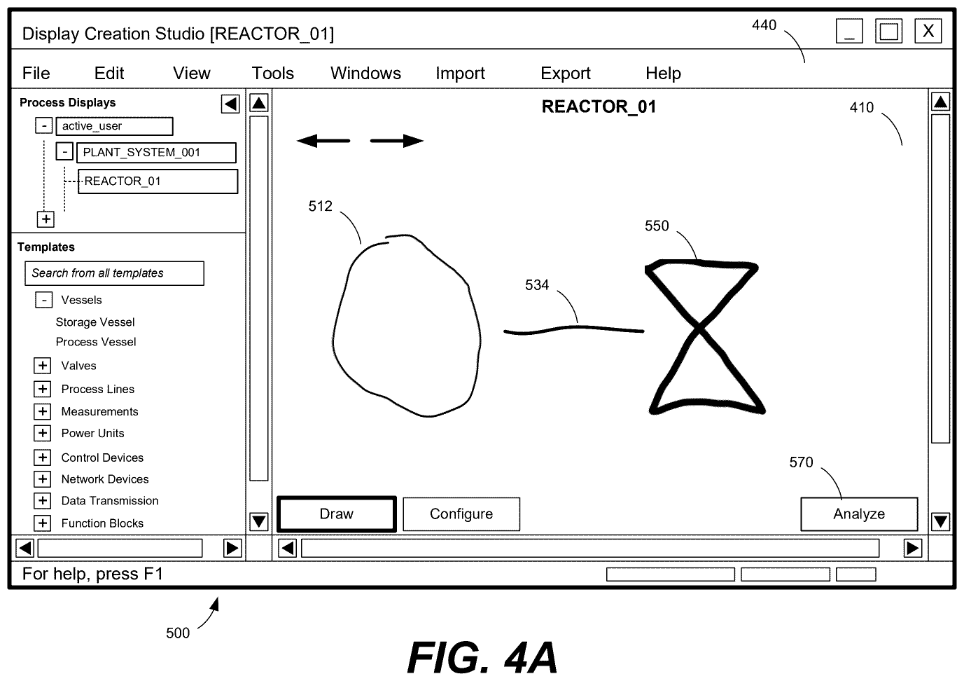

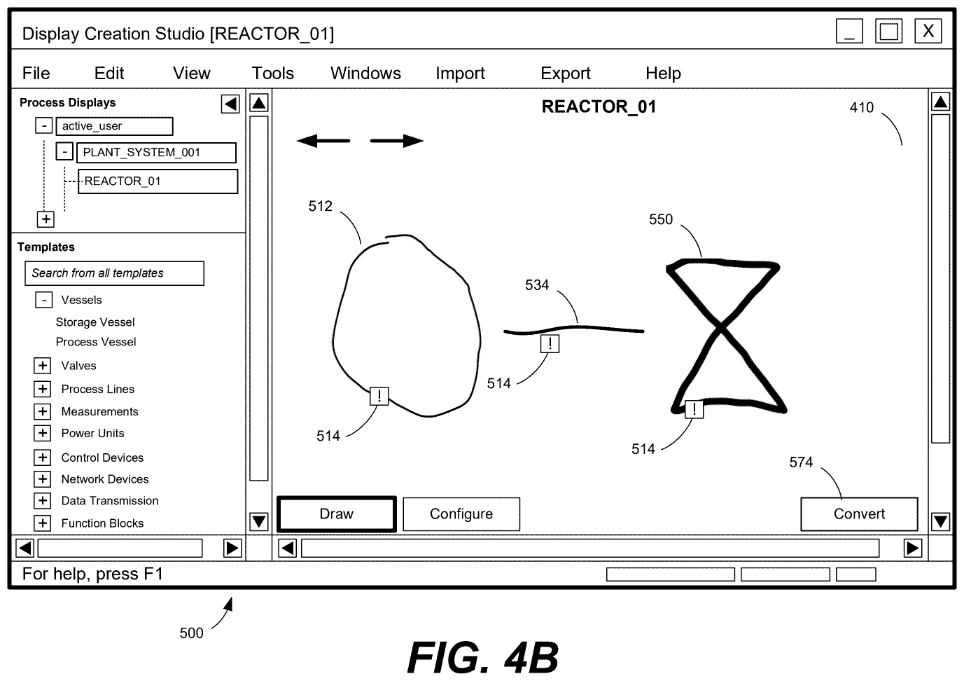

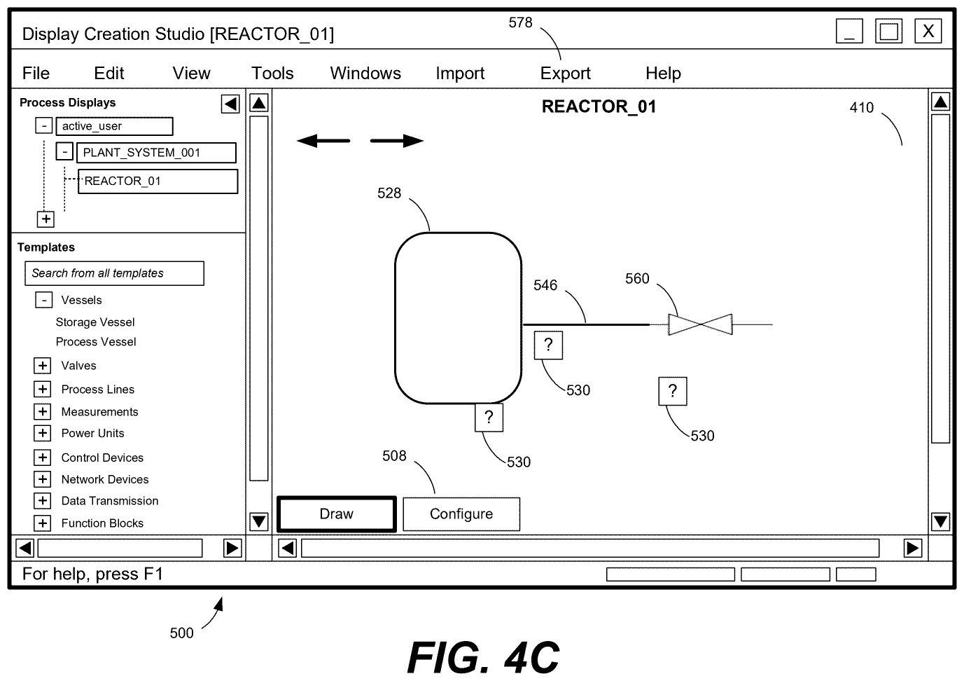

FIG. 4A illustrates an example use case in which lines 534 and shapes 512 and 550 are drawn prior to any of the lines/shapes being converted to process template objects. For example, the use case of FIG. 4A may correspond to the user importing a hand-drawn sketch of a process display or a sketch produced via a different computer application (alternatively, the user simply may have continued to draw lines/shapes on a touchscreen before converting any of the drawn lines/shapes). In embodiments, the drawing is uploaded via the “Import” feature depicted in the top menu region 440, which enables the user to upload drawings of an appropriate file format to the display creation application (e.g., the user may upload a .jpg, png, or a .pdf file).

In embodiments depicted in FIG. 4A, the GUI 500 may display an “Analyze” icon 570 responsive to receiving an imported drawing or otherwise receiving a plurality of shapes/lines that have not yet been translated to template objects. Responsive to the user selecting the icon 570, the GUI 500 causes the gesture recognition algorithm to be executed to identify the respective lines/shapes in the canvas region 410 and identity one or more process entities for each respective line/shape. As illustrated in FIG. 4B, the GUI 500 displays instances of the icon 514 adjacent to each respective line/shape indicating one or more process entities and corresponding templates being identified. The user may select the icon 514 for a particular line or shape to display and select, from among one or more process template options, a process template for inclusion in the process display (e.g., in the manner described with respect to FIGS. 3B-3J). Alternatively, the user may select a “Convert” icon to cause the GUI 500 to automatically convert each of the identified lines/shapes to a process template corresponding to the most likely process entity identified by the gesture recognition algorithm for each line/shape. In any case, as shown in FIG. 4C, the GUI 500 displays process templates corresponding to the input from FIG. 4A. The GUI 500 provides instances of the icon 530 adjacent to each respective process template instance e.g., to enable the user to select a different process template for inclusion in the process display.

Still alternative approaches are possible with respect to the use case of FIGS. 4A-4C. For example, in some embodiments, responsive to receiving an uploaded drawing, the GUI 500 automatically implements the gesture recognition algorithm to identify the one or more process entities for each of the lines/shapes 512, 534, and 550. Additionally, or alternatively, in some embodiments, responsive to identifying the one or more process entities for each of the lines/shapes 512, 534, 550, the GUI 500 automatically converts each of the lines/shapes 512, 534, 550 to a corresponding process template (e.g., the template for the most likely entity identified for each respective one of the lines/shapes 512, 534, and/or 550).

In any case, referring again to FIG. 4C, the user may select an “Export” option 578, e.g., to save the process display to one or more local storage devices (e.g., local storage, external media storage, network storage, etc.) to upload the process display to one or more servers, and/or to provide storage and/or and provide the created process display to one or more other applications. The one or more other applications may allow the user to configure the process display for use in a particular process environment, e.g., by tying the process templates to respective entities in a real process plant environment based upon one or more configuration files defining operation of the process environment (e.g., an .fhx file). In some embodiments, selection of the “Configure” icon 508 in FIG. 4C enables the user to perform this configuration of the process display within the display creation application or within a similarly capable application, as will be described below with respect to FIG. 5.

### Example Process Display Configuration

FIG. 5 illustrates a configuration mode of the GUI 500 that the user may access, for example, by selecting the configure icon 508 or the export option 578 described with respect to FIG. 4C and other preceding figures. As depicted in FIG. 5, the configuration mode of the GUI 500 condenses the canvas region 410 to facilitate display of a configuration region 580 including sub-regions 582-1 through 582-5, via which the user may configure the created process display for use in the process plant or module. Access to the configuration region 580 may be limited to only users with particular authorizations within the process plant environment (e.g., the user may only configure a process display for a particular portion of the process plant environment to which the user has access). Generally, operations in the configuration region 580 allow the user to select various devices and modules associated with a process plant, information regarding which the GUI 500 may obtain via a configuration file defining the devices and modules in the process plant (e.g., an FHX configuration file).

More specifically, via a drop-down menu in the sub-region 582-1, the user may select a process environment (“plant”) for which the process display is to be configured. Process environments displayed in the sub-region 582-1 may be limited to only those process environments to which the active user of the display creation application (“active_user”) has at least some level of access privileges. For example, an operator, engineer, or maintenance person working in some portion of the environment “PLANT_SYSTEM_001” may be allowed to select the environment to configure the process display REACTOR_001 for use therein, whereas personnel not associated with the environment may not be able to configure the process display.

Next, using sub-region 582-2, the user may use another drop-down menu to select a module within the selected process environment for which the created process display is to be used. Modules available for selection in the sub-region 582-2 may be limited to only those process modules where the user has at least some level of access privileges. Moreover, in some embodiments, modules available for selection in the sub-region 582-2 may be limited based upon the entities present in the process display, e.g., only modules containing at least one interconnected tank, process fluid line, and valve may be made available to be selected.

Upon selecting a module, the user may use the sub-region 582-3 to tie individual process templates from the process display to corresponding entities in the selected process module. For example, the user may select the tank template 528 from the canvas region 410, causing a depiction of the tank template 528 to appear in the sub-region 582-3. The user may use still another drop-down menu to select the particular process entity for which its operation is to be depicted via the tank template 528. Process entities available for selection via the drop-down menu in the sub-region 582 may be limited to only those entities that correspond to the selected template. For instance, in the example of FIG. 5, the user may select any tank in the selected process module to correspond to the selected tank template 528 (or more specifically, any tank that connected to a fluid line and/or to a valve in the specific manner shown in the process display). The user may not, however, select other process entities in the process module that would instead be depicted via different process templates, e.g., the user cannot tie the tank template 528 to power generation equipment, data storage devices, network equipment, sensors, etc. Still referring to the sub-region 582-3, the user may use the “check mark” icon to confirm the configured correspondence of the selected process entity to the selected template, or the adjacent “X” icon to remove the configured correspondence. The user may repeat this process within sub-region 582-3 for each template included in the created process display, so as to tie each process template to a corresponding process entity to enable the created process display to be used in the selected process module. In some embodiments, the GUI 500 automatically modifies properties associated with the template object instances to match those of the corresponding process entities in the selected process module. In these embodiments, the display creation application may save a copy of the created process display, e.g., to enable the unmodified version of the process display to be configured later with respect to different process plant environments and/or modules.

Still referring to the configuration region 580 in FIG. 5, the user may use the sub-region 582-4 to select one or more devices at which the configured process display is to be displayed during operation. Selecting a device in the sub-region 582-4 may cause the GUI 500 to communicate with the selected device to download the process display to the selected device, e.g., for execution and display during on-line operation of the process plant. During operation of the process module, a process controller and/or other entities associated with the process module may continue to communicate with the selected device substantially in real time, e.g. to update operational parameters, statuses, alarms, etc. that the process display was created to depict.

Via the sub-region 582-5, the user may cause the configured process display to be downloaded to one or more devices associated with the process module to thereby implement the configured process display during operation of the process module. For example, the GUI 500 may download the configured process display to one or more process controller, data historians, and/or other devices that are configured to, during operation of a process, obtain and distribute information to which the process display pertains, to thereby enable the process display to be updated substantially in real time at operator displays, portable devices, etc. at which the process display is being viewed. Additionally, or alternatively, the GUI 500 may download the configured process display locally to a viewing application at the user device at which the display creation application is executed.

### Example Artificial Neural Network

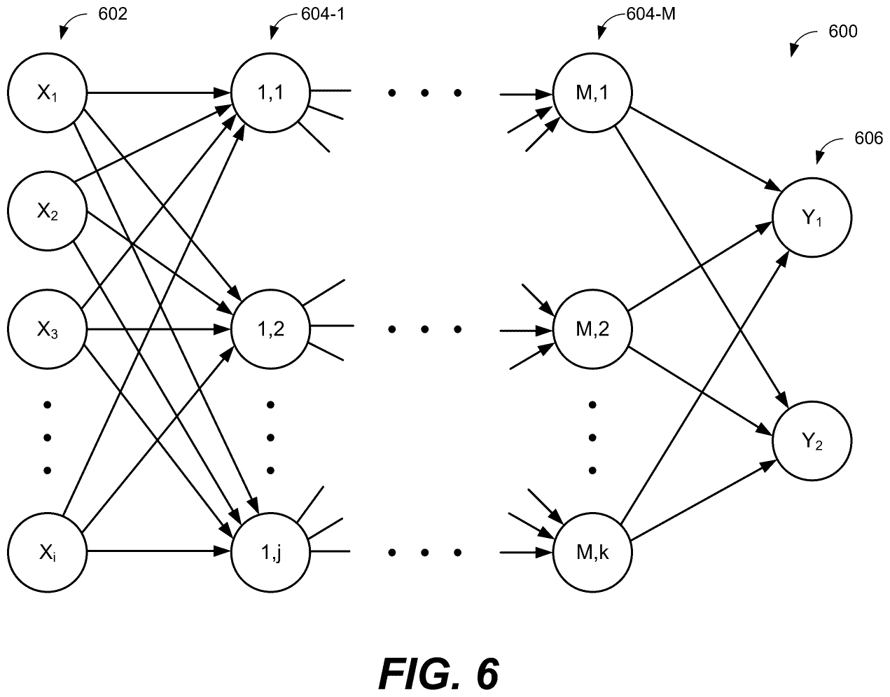

In some embodiments the gesture recognition algorithm of the present disclosure may utilize one or more machine learning structures, such as an artificial neural network. FIG. 6 illustrates elements of an example neural network 600 that the gesture recognition algorithm employs, in some embodiments. The neural network 600, generally, may be trained to recognize one or more process entities (and corresponding templates) based upon gestures forming lines/shapes in the canvas region of the display creation application. The neural network 600 can be implemented, for example, at one of the workstations 14 of FIG. 1 executing the display creation application, and/or at one or more servers or other computing devices with which the display creation application is communicatively connected.

The neural network 600 includes a multiplicity of neurons arranged in multiple layers, and includes an input layer 602, one or more intermediate layers 604-1 through 604-M (“hidden layer(s)”), and an output layer 606. M may be any integer greater than or equal to one. Each of the layers 602, 404-1 through 604-M, and 606 may have any number of inputs/neurons/outputs (e.g., the layer 604-1 including neurons “1, 1” through “1, j,” wherein j represents the number of neurons in layer 604-1). Each layer may have same or different numbers of inputs/neurons/outputs. Various other configurations of the neural network 600 are possible.

Inputs in the input layer 602 may include one or more gestures drawn in a canvas region of the display creation application, the one or more gestures forming one or more lines/shapes from which the gesture recognition algorithm is to identify a process entity. Inputs in the input layer 602 may further include other contextual information that may indicate what process entity a user intends to represent via the gesture(s). For example, inputs in the input layer 602 may include indications of a name of the process display, a plant environment in which the process display has been created, and/or what other process templates are already included adjacent to the drawn gesture(s) or elsewhere in the process display.

In embodiments, training of the neural network 600 is achieved via providing labeled training data to the neural network 600. Labeled training data generally includes examples of gestures and/or other inputs known to correspond to a particular output, e.g., a set of one or more lines/shapes (and/or other input) that is known to correspond to a particular process entity intended to be represented by the lines/shapes. Training of the neural network 600 may be ongoing during user operation of the display creation application to adapt the neural network 600 based upon selections of identified process templates, e.g., as described with respect to FIGS. 3A-3J. For example, if the neural network 600 produces a determination of the most likely process entity corresponding to a shape but the user selects a process template corresponding to a different process entity, the neural network 600 may adapted toward the selected process entity in a manner that makes the neural network 600 more likely to produce more accurate identifications of the correct process entity the future.

Each of the intermediate layers 604-1 through 604-M may include any number of neurons, and a different number of neurons at each layer is possible. Each intermediate layer neuron may operate on one or more inputs from the input layer 602 and/or one or more outputs of other layers (e.g., a preceding intermediate layer), to generate a decision or other output. At least a portion of the hidden layers 604-1 through 604-M may correspond to shape recognition computations, contextual recognition, and/or other operations for identifying process templates based upon inputs of the input layer 602.

The output layer 606 includes outputs y₁ and y₂, although additional or fewer outputs are possible in various embodiments. In any case, each output of the neural network 600 correspond to a process entity (and the corresponding template object(s)) identified by the neural network 600 as being represented by the inputs from the input layer 602. In embodiments, one, two, three or more process entities (i.e., outputs) are identified as corresponding to the inputs from the input layer 602, and each output is associated with a confidence score corresponding to a degree of likelihood that the output is the process entity intended to be represented by the received gesture(s). Accordingly, outputs may be ranked in an order that effectively corresponds to confidence or likelihood that the respective output corresponds to the received input. In embodiments, the confidence score is normalized to values between 0 and 1. For example, in an example scenario in which the line 534 from FIGS. 3E-3G (i.e., the one or more gestures of which the line 534 is composed) is provided as an input to the neural network 600 in the input layer 602, outputs in the output layer 606 include at least the process fluid line template option 540, the process fluid cooling line template option 542, and the data link template option 544. The fluid line template 540, having the highest corresponding score in the output layer 606, is identified as the most likely process entity (or “top output”) from the neural network 600.

In some embodiments, the neural network 600 is a recurrent neural network, wherein decisions or outputs from at least one layer of the neural network 600 are fed back to at least one previous layer during training to provide an indication of significance (e.g., a “weight”) of a particular input or intermediate layer output in determining a particular decision or calculation. For example, in some embodiments outputs of an intermediate layer 604 and/or output layer 406 are utilized to weight input metrics at the input layer 602. As a result of training, in some embodiments, insignificant inputs of input layer 602, and/or insignificant neurons of layers 604-1 through 604-M, may be bypassed in order to reduce processing demands in determining classifications.

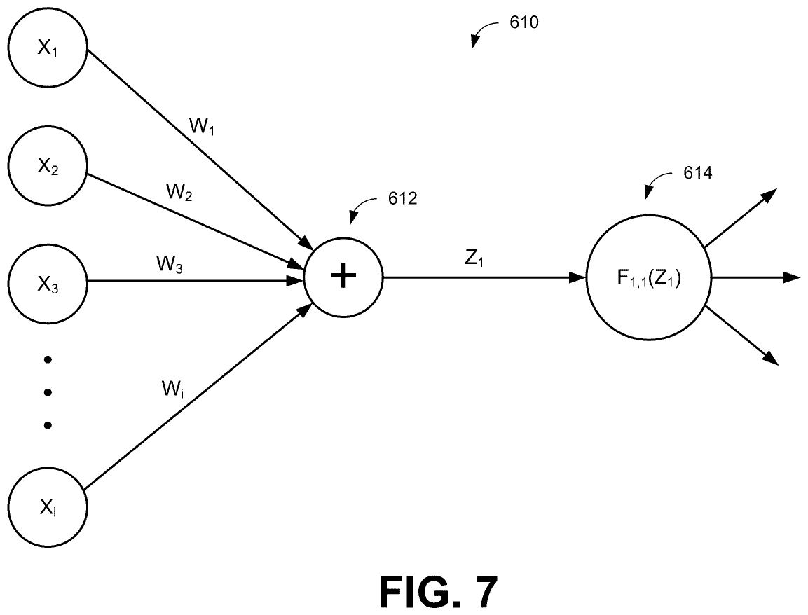

FIG. 7 depicts an example neuron 612 that may correspond to a particular neuron of the neural network 600 of FIG. 6 (e.g., a neuron “1, 1” of the layer 604-1). At least one of inputs x₁ through xᵢ is provided to the neuron 612. A particular input may be, for example, an input to the neural network 600 itself as described with respect to FIG. 6, or an output of a neuron of another layer of the neural network 600. Each input is assigned a respective weight (W₁ through Wᵢ), wherein the weight of each input is determined during the initial process of training the neural network 600 and/or further adjusted during subsequent use of the display creation application (e.g., weights of the neurons are adjusted based upon whether the process template chosen by the user was the top output produced by the neural network 600). In some cases, an input is determined to be insignificant to a decision or calculation of a neuron, and may accordingly be assigned a zero or near-zero weight.

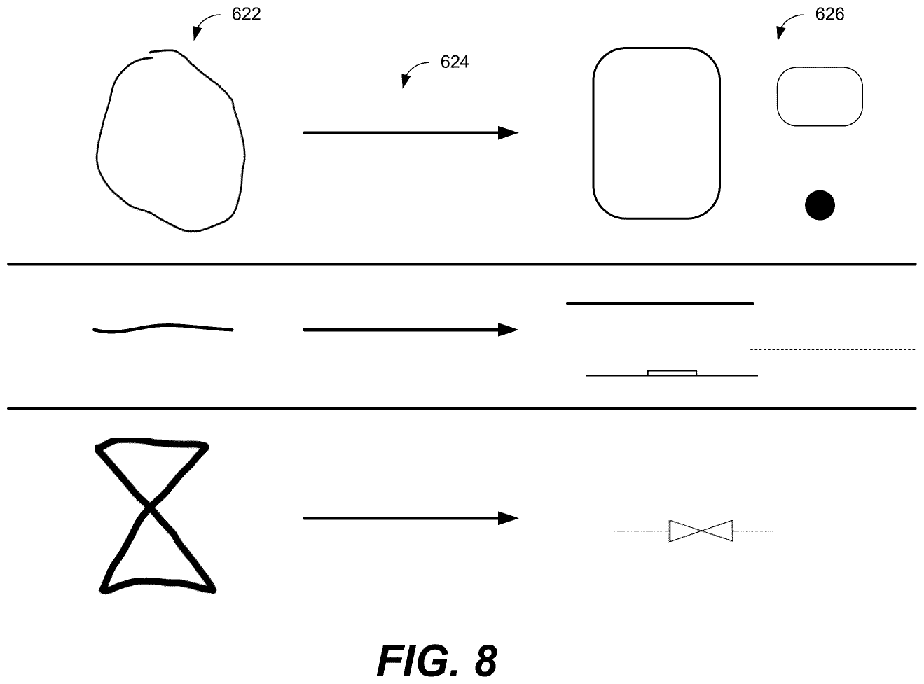

FIG. 8 illustrates examples of inputs and corresponding outputs in example operations of the neural network 600 of FIGS. 6 and 7. In each example, the left column 622 corresponds to a line or shape formed by one or more gestures drawn by the user, e.g., in the canvas region 410 of the GUI 500 as described with respect to FIGS. 3A-3J. The right column 626 corresponds to, for each line or shape, one or more process templates identified by the neural network 600 as corresponding to the drawn line or shape. Accordingly, the center column 624 corresponds to the operations of the neural network 600, including the provision of any additional inputs to the neural network 600 (e.g., indications of co-located process templates which may serve as contextual clues for what process entity the user is attempting to draw), and the operations of intermediate layers 604-1 through 604-M.

### Example User Device and Server

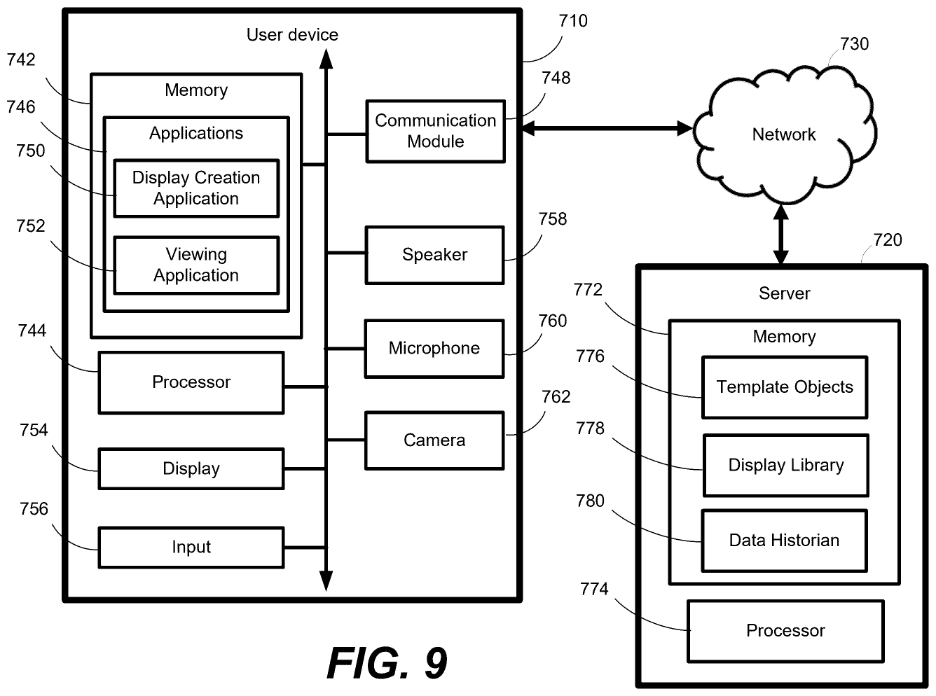

FIG. 9 illustrates a block diagram of example components of a user device 710 and a server 720 communicating over a network 730, in accordance with embodiments of the process display creation techniques described in this detailed description.

The user device 710 generally corresponds to the device at which the display creation application executes. The user device may be, for example, one of the workstations 14 described with respect to FIG. 1, or a portable device in the possession of an operator or other plant personnel associated with operation of a process plant. The server 720 (i.e., one or more servers), generally speaking, may operate to facilitate operation of the process plant and/or execution of the display creation application at the user device 710. The network 730 may include any suitable one or more communications networks in accordance with the respective capabilities and/or operations of the user device 710, server 720, and/or other devices in the process plant. The network 730 may include the Internet, a wired or wireless local area network (LAN), and/or a cellular communications network. Accordingly, communications over the network 730 may include any suitable one or more communications protocols such as a cellular communications protocol (e.g., CDMA, GSM, EV-DO, LTE, IP, etc.), one or more IEEE 802.11 protocols (e.g., Wi-Fi), Bluetooth, a process communication protocol (e.g., the Fieldbus protocol, the HART protocol, a wireless HART protocol or other wireless protocol, the 4-20 ma analog protocol, etc.), and/or other suitable protocols.

The user device 710 includes a memory 742 which may include one or more non-transitory memories (e.g., ROM) and/or one or more volatile memories (e.g., RAM). In particular, non-transitory portions of the memory 742 store non-transitory, computer executable instructions that are executable by a processor 744 (i.e., one or more processors) to cause the user device 710 to perform actions described herein. Non-transitory portions of the memory 742 include applications 746. Each respective application 746 generally includes one or more sets of non-transitory computer executable instructions that, when executed by the processor 744, cause the user device 710 to perform operations associated with the respective application 746 (e.g., operations involving the processor 744, a communication module 748, and/or other components of the user device 710 discussed herein). The applications 746 include the display creation application 750 (e.g., display creation application 51 from FIG. 1) and a viewing application 752 (e.g., viewing application 54 from FIG. 1). Additional or alternative applications are possible. For example, in some embodiments, the applications 746 include the process module configuration application 50 from FIG. 1, and/or other applications to facilitate configuration, operation, and/or supervision of the process plant.

The user device 710 includes a display unit 754 (i.e., one or more display devices, such as a touch-enabled visual display (“touchscreen”) or other visual display). The user device 710 further includes an input unit 756 (i.e., one or more user input devices, e.g., a touchscreen or touchpad, a keyboard, a mouse, etc.). In some embodiments, aspects of the display unit 754 and input unit 756 are integrated (e.g., as a touchscreen with both touch input and display capability). The display unit 754 and/or the input unit 756 may be physically included within the user device 710 (e.g., a fixedly installed touchscreen), or may be operatively coupled with the user device 710 by other means (e.g., a peripheral touch pad, mouse, keyboard, etc. connected to the user device 710 by wired and/or wireless means).

The user device 710 includes a speaker 758, a microphone 760, and/or a camera 762 (e.g., a motion-aware camera). In some embodiments, the user device 710 includes still other sensor components, e.g., a positioning unit (e.g., GPS), an accelerometer, a gyroscope, etc. The speaker 758, microphone 760, camera 762, and/or one or more other sensor components may be physically included within the user device 710 (e.g., a natively installed speaker, microphone, or camera), and/or may be operatively coupled with the user device 710 by other means (e.g., a peripheral camera, speaker, or microphone connected to the user device 710 by wired and/or wireless means). The speaker 758, microphone 760, camera 762, and/or one or more other sensor components, generally speaking, may enable voice-controlled or motion-controlled operations of the display creation application 750, viewing application 752, and/or other applications at the user device 710, and/or may enable locational or environmental awareness at the user device 710.

Collectively, components of the user device 710 operate to display one or more graphical user interfaces (GUIs) of the display creation application 750 that enable functionalities described herein, for example as described with respect to FIGS. 2, 3A-3J, 4A-4C, and 5. In some embodiments, user interfaces are provided at least partially by the speaker 758, microphone 760, camera 762, and/or other sensor components, e.g., to enable voice-based, gesture-based, and/or motion-based interactivity for the user interfaces.

The server 720 (i.e., one or more servers) includes a memory 772, which may include one or more non-transitory memories (e.g., ROM) and/or one or more volatile memories (e.g., RAM). In particular, non-transitory portions of the memory 772 store non-transitory, computer executable instructions that are executable by a processor 774 (i.e., one or more processors) to cause the server 720 to perform actions described herein. Non-transitory portions of the memory 772 include a library of template objects 776 upon which the display creation application 750 of the user device 710 operates. Non-transitory portions of the memory 772 further include a display library 778 storing existing process displays. The display library 778 generally enables process displays to be imported to the display creation application 750 at one or more devices, and/or exported from the display creation application 750 to the memory 772, thereby allowing for sharing and editing of process displays across multiple devices and personnel associated with the process plant. Non-transitory portions of the memory 772 still further include a data historian application 780 including instructions to cause the server 720 to collect and distribute information associated with present and past operation of the process plant. Upon collecting information associated with operation of the process plant, the data historian application 780 distributes the information to devices at which the process displays are executed (e.g., via the viewing application 752) to enable process displays to be updated to reflect operation of the portion(s) of the process plant environment that the process displays are configured to visually depict.

The user device 710 and/or server 720 may include additional, fewer, and/or alternate components, and may be in communication with additional devices, in various embodiments.

### Example Computer-Implemented Methods

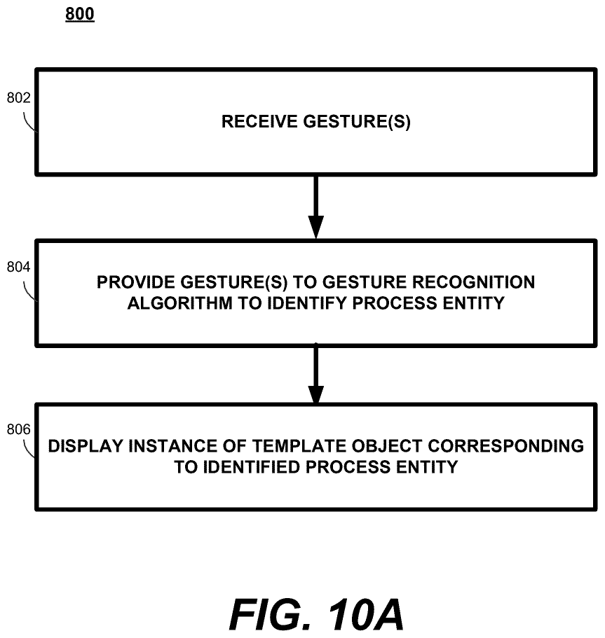

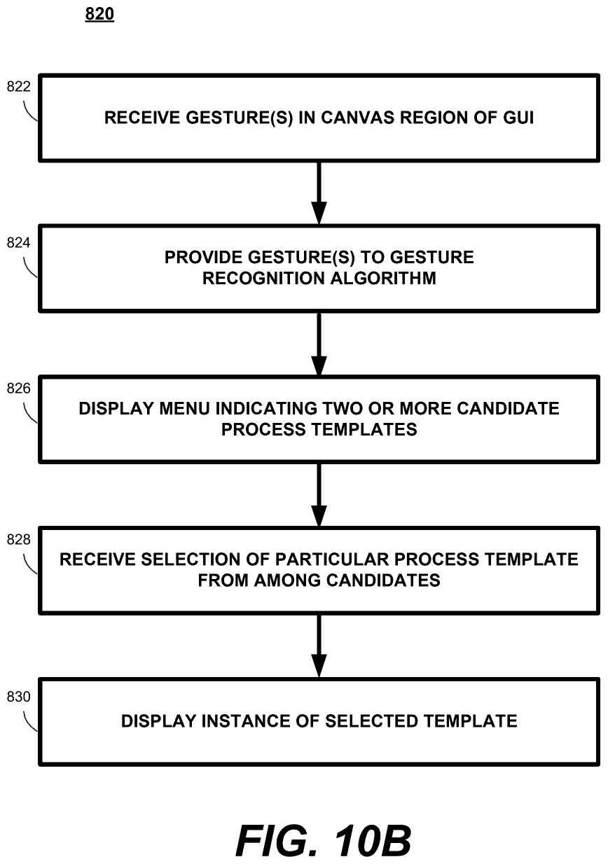

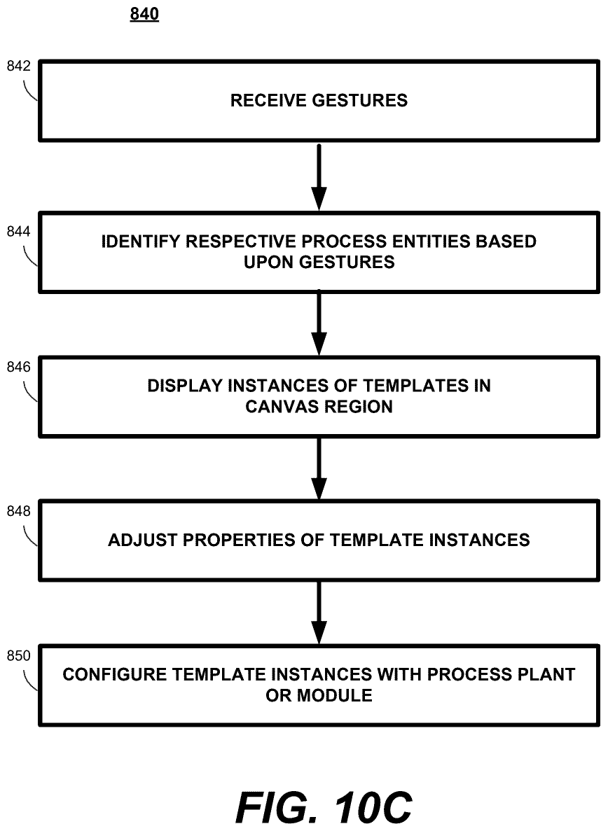

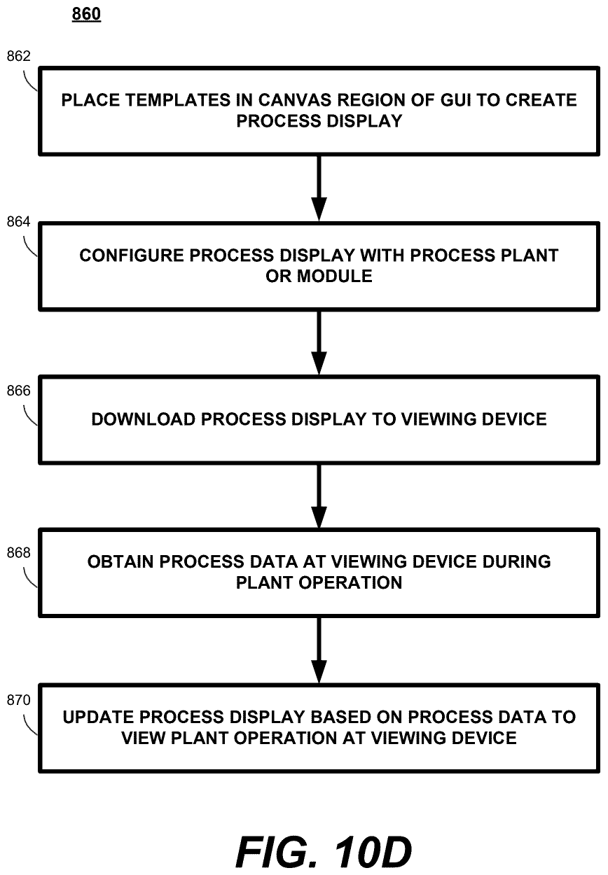

FIGS. 10A-10D illustrate block diagrams of example computer-implemented methods associated with the techniques of the present disclosure. In various embodiments, actions of the methods of FIGS. 10A-10D are executed via one or more computing elements described with respect to the foregoing figures (e.g., workstation 14 of FIG. 1, user device 710 and/or server 720 of FIG. 9). More particularly, actions of the methods of FIGS. 10A-10D may be executed via one or more processors of the one or more computing elements, executing one or more sets of machine-readable instructions stored at one or more non-transitory computer memories. Various modifications to the methods of FIGS. 10A-10D are possible, for example based upon the systems and methods described throughout this detailed description.

FIG. 10A illustrates a block diagram of an example computer-implemented method 800 associated with creating a process display via a display creation application. The method 800 may be executed, for example, at a user device, such as a workstation or portable computing device of a person associated with a process plant (e.g., workstation 14 of FIG. 1 and/or user device 710 of FIG. 9). Actions of the method 800 may be performed via one or more processors of the user device upon execution of machine-readable instructions stored at one or more non-transitory computer-readable media associated with the user device (e.g., non-transitory internal memory or external non-transitory media storage).

The method 800 includes receiving, from a user of a user device, one or more gestures forming at least one line or shape (802, e.g., via mouse interactions, touch interactions, motion-based input, etc.). In some embodiments, the one or more gestures are rendered on the GUI as the one or more gestures are provided by the user. In some embodiments, the gestures are received in the form of a hand-drawn sketch scanned and imported to the display creation application, or in the form of a machine-printed drawing imported to the display creation application.

The method 800 further includes providing the one or more gestures as one or more inputs to a gesture recognition algorithm (804). The gesture recognition is executed at the user device, in some embodiments. Additionally, or alternatively, in some embodiments, the gesture recognition algorithm is executed at one or more remote computing devices (e.g., a GUI provides input to one or more servers and receives one or more outputs of the gesture recognition algorithm determined via the one or more servers). In embodiments, the gesture recognition algorithm includes a machine learning structure such as an artificial neural network. Moreover, in some embodiments, additional inputs are provided to the gesture recognition algorithm, e.g., the gesture recognition algorithm takes into account one or more other process templates located near a location in a canvas region corresponding to the received gesture(s), and/or based on other factors described in this detailed description. Providing the one or more gestures to the gesture recognition algorithm, in some embodiments, is performed responsive to a selection of an icon or other visual element by the user via a graphical user interface (GUI, e.g., the GUI presents an icon near a drawn line or shape responsive to receiving the one or more gestures, wherein the gesture recognition algorithm is performed upon the user selecting the icon). Alternatively, in some embodiments, the GUI automatically provides the one or more gestures to the gesture recognition algorithm as the GUI receives the one or more gestures.

In any case, executing the gesture recognition algorithm based at least upon the one or more gestures produces an identification of a process entity (i.e., at least one process entity) represented by the one or more gestures (e.g., the process entity the user intended to draw). The process entity is identified from among a plurality of defined process entities associated with a process plant, and each process entity is associated, respectively, with a corresponding process template object preconfigured to visually represent the corresponding process entity in a process display. In some embodiments, a process entity can have two, three, or more template objects associated therewith.

In some embodiments, the gesture recognition algorithm outputs two, three, or more process entities potentially corresponding to the received one or more gesture(s), and the user may select from among templates respectively corresponding to these two, three, or more “candidate process entities” to indicate which process template is to be provided in the canvas region. For example, A GUI upon receiving the output of the candidate process entities may display a menu overlay for selection of a particular process entity from among the two or more candidate process entities. The gesture recognition algorithm may be responsively adapted based upon the selection, i.e., based upon whether the chosen process template object was the top output of the gesture recognition algorithm.

The method still further includes, based upon the identification of the process entity, displaying an instance of a template object corresponding to the identified process identity in a canvas region of a graphical user interface (GUI) executing at the user device (806). The template object (and hence, the instance thereof) is configured to provide a visual representation of operation of the identified process entity in the process plant, to form at least a portion of a process display. For example, the template object may include default and/or modifiable settings, methods, dimensions, animations, event handler behaviors, and/or other properties affecting the appearance and/or operation of an instance of the template object during execution of the process display. Accordingly, the method 800 in various embodiments includes modifying one or more properties associated with the template object instance based upon input from the user. In some embodiments, the GUI automatically resizes and/or repositions the instance of the template object in the canvas region, e.g., to make the size of the template object proportional to other elements of the process display and/or to align an edge of the template object instance with one or more other elements of the process display (e.g., “snapping” a fluid line to an input of a valve through which the fluid line provides a process fluid).

In some embodiments, the GUI further enables the user to configure the process display for use in at least a portion of the process plant. For example, the GUI may obtain information from one or more configuration files of the process plant (e.g., an .fhx file) defining the real process entities operative in the particular portion of the process plant. In these embodiments, the GUI enables the user to choose respective template objects included in the canvas region and assign the respective template objects to respective ones of the real process entities. Upon configuring the process display for use in the process plant, the user may cause the process display to be downloaded to one or more devices for viewing of the process display in a viewing application, e.g., during on-line operation of a process in the process plant. During viewing in the viewing application, the viewing application receives process data defining past, present, and/or future operation of the process, and cause elements of the process display to be updated to reflect the operation of the process plant (e.g., to display operating parameters, events, alarms, levels, etc.). Moreover, in some embodiments, the user causes the process display to be uploaded to one or more servers, for subsequent use and/or modification of the process display at one or more other user devices using the display creation application.

In some embodiments, the method 800 includes defining one or more new process templates for use in process displays (e.g., a new tank template, fluid line template, etc., including the default and/or modifiable properties associated therewith). Additionally, or alternatively, in some embodiments, the method 800 includes defining a new association between one or more gestures and one or more process entities (e.g., to define that a rhombus shape or a series of three vertical lines corresponds to a particular process entity and hence the template object(s) associated therewith). The gesture recognition algorithm may be automatically adapted automatically based upon the new association, such that the gesture recognition algorithm subsequently produces output in view of the new association.

The method 800 may include additional, fewer, and/or alternate actions, in various embodiments.

FIG. 10B illustrates a block diagram of another example computer-implemented method 820 associated with creating a process display. More particularly, the method 820 is associated with selecting a process entity from among two or more candidate process entities produced by a gesture recognition algorithm, e.g., as described with respect to the method 800 of FIG. 10A. The method 820 may be executed, for example, at a user device, such as a workstation or portable computing device of a person associated with a process plant (e.g., workstation 14 of FIG. 1 and/or user device 710 of FIG. 9). Actions of the method 820 may be performed via one or more processors of the user device upon execution of machine-readable instructions stored at one or more non-transitory computer-readable media associated with the user device (e.g., non-transitory internal memory or external non-transitory media storage).

The method 820 further includes receiving one or more gestures forming one or more lines and/or shapes (822, e.g., as described with respect to action 802 from FIG. 10A). The method 820 still further includes providing the one or more gestures as inputs to a gesture recognition algorithm to identify two or more candidate process entities that potentially correspond to the received one or more gestures (824). A graphical user interface (GUI) subsequently displays a menu indicating candidate process templates respectively corresponding to the two or more candidate process entities (826), and receives a selection of a particular template object from among the two or more candidate template objects (828). In some embodiments, the two or more candidate process entities output by the gesture recognition algorithm are ranked based upon likelihood or confidence that the respective process entity corresponds to the received gesture(s), and accordingly, the menu presented at action 826 lists the two or more candidate process templates in order of ranking. In some embodiments, if a particular candidate process entity does not exceed a threshold ranking or score as output by the gesture recognition algorithm, the process entity is omitted from the menu at action 826. In any case, the method 820 includes displaying an instance of the selected template object (830). Subsequently, the user may modify appearance, behavior, position, and/or other properties of the template object instance, e.g., as described with respect to the method 800 of FIG. 10A and elsewhere in this detailed description.

The method 820 may include additional, fewer, and/or alternate actions, in various embodiments.

FIG. 10C illustrates a block diagram of an example computer-implemented method 840 associated with configuring a process display for use in a particular process plant or portion thereof. The method 840 may be executed, for example, at a user device, such as a workstation or portable computing device of a person associated with a process plant (e.g., workstation 14 of FIG. 1 and/or user device 710 of FIG. 9). Actions of the method 840 may be performed via one or more processors of the user device upon execution of machine-readable instructions stored at one or more non-transitory computer-readable media associated with the user device (e.g., non-transitory internal memory or external non-transitory media storage).

The method 840 includes receiving gestures (842, e.g., via touchscreen input, mouse input, motion-based input, etc.). The method further includes identifying respective process entities based upon respective sets of one or more gestures (844), and displaying instances of template objects corresponding to the identified process entities in a canvas region (846). For each template object displayed in the canvas region, the identification of the process entity and displaying of the corresponding template object can include any of the elements described with respect to similar actions in the methods of FIGS. 10A and/or 10B. In any case, the displayed template object instances and other elements collectively form a process display, and the GUI adjusts properties of the template object instances based upon subsequent user interactions (848). For example, the user may modify dimensions, settings, methods, animations, event handler behaviors (e.g., alarms), etc. associated with the template object instances, e.g., to more closely match a process environment in which the user envisions that the process display will be executed. The method 840 still further includes configuring the template object instances with respective entities in a process plant or a module therein (850, e.g., a process module), e.g., by tying each template object instance to a corresponding real process entity in the plant or module.

The method 840 may include additional, fewer, and/or alternate actions, in various embodiments.

FIG. 10D illustrates a block diagram of an example computer-implemented method 860 associated with executing a process display at a viewing device. The method 860 may be executed, for example, via a combination of one or more user devices, one or more servers, and/or other devices associated with a process plant. In any case, actions of the method 860 may be performed via one or more processors of one or more devices upon execution of machine-readable instructions stored at one or more non-transitory computer-readable media associated with the one or more devices (e.g., non-transitory internal memory or external non-transitory media storage).

The method 860 includes placing process template object instances in a canvas region of a graphical user interface (GUI) to thereby create a process display (862). The creating of the process display at action 862 can include any suitable actions described with respect to FIGS. 10A-10C and elsewhere in this detailed description. The method 860 further includes configuring the created process display with a process plant or a portion thereof (864, e.g., a defined process module), e.g., as described with respect to the method 840 of FIG. 10C. The method 860 still further includes downloading the created process display to one or more devices (“viewing devices”) for viewing of the process display (866), e.g., via a viewing application during on-line operation of the at least the portion of the process plant for which the process display was configured. Still additionally, the method 860 includes obtaining process data at the viewing application at a viewing device (868). The viewing device may obtain the process data, for example, from a data historian or another device configured to collect and distribute data associated with past, present, and/or future operation of the process plant. In any case, the method 860 includes displaying and updating the process display based upon the obtained process data (870), to thereby enable a user of the viewing device to view operation of at least a portion of the process plant for which the process display was configured. Updating the process display, generally, includes updating appearances, behaviors, alarms, etc. based upon the process data and further based upon the manner in which the template object instances in the process display were configured to respond to process data (e.g., a fluid line template object is configured to display an alarm based upon a threshold value of a temperature of a process fluid passing through the fluid line).

The method 860 may include additional, fewer, and/or alternate actions, in various embodiments.

### Additional Considerations

When implemented in software, any of the applications and functions described herein may be stored as instructions in any tangible, non-transitory computer readable memory such as on a magnetic disk, a laser disk, solid state memory device, molecular memory storage device, or other storage medium, in a RAM or ROM of a computer or processor, etc. Although the example systems disclosed herein are disclosed as including, among other components, software and/or firmware executed on hardware, it should be noted that such systems are merely illustrative and should not be considered as limiting. For example, it is contemplated that any or all of these hardware, software, and firmware components could be embodied exclusively in hardware, exclusively in software, or in any combination of hardware and software. Accordingly, while the example systems described herein are described as being implemented in software executed on a processor of one or more computer devices, persons of ordinary skill in the art will readily appreciate that the examples provided are not the only way to implement such systems.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims. By way of example, and not limitation, the disclosure herein contemplates at least the following aspects:
1. One or more tangible, non-transitory computer readable media storing machine-readable instructions that, when executed by one or more processors of a user device, cause the user device to (1) receive one or more gestures forming at least one line or shape in a gesture input region, the one or more gestures being provided by a user, (2) provide the one or more gestures as one or more inputs to a gesture recognition algorithm to identify, based at least upon the received one or more gestures, a process entity represented by the received one or more gestures, the process entity being identified from among a plurality of process entities having respective template objects associated therewith, and (3) based upon the identification of the process entity, display, in a canvas region of a graphical user interface (GUI) executing via the user device, of an instance of a template object corresponding to the identified process entity, the template object being configured to provide a visual representation of operation of the identified process entity in a process plant to thereby form at least a portion of a process display.
2. The one or more tangible, non-transitory computer readable media of aspect 1, wherein receiving the one or more gestures comprises detecting the one or more gestures via one or more cameras associated with the user device.
3. The one or more tangible, non-transitory computer readable media of aspect 1, wherein the gesture input region is the canvas region of the GUI, and wherein the one or more gestures are received via one or more touch interactions corresponding to the canvas region.
4. The one or more tangible, non-transitory computer readable media of aspect 1, wherein the canvas region is displayed via a visual display of the user device, and wherein the one or more gestures are received via the one or more touch interactions at a touch-aware surface separate from the visual display of the user device, and wherein receiving the one or more gestures comprises mapping respective locations of the one or more touch interactions at the touch-aware surface to a corresponding respective locations of the visual display.
5. The one or more tangible, non-transitory computer readable media of any one of aspects 1 to 4, wherein the instructions, when executed by the one or more processors, further cause the user device to display the at least one line or shape in the canvas region of the GUI upon receiving the one or more gestures.
6. The one or more tangible, non-transitory computer readable media of aspect 5, wherein the instructions, when executed by the one or more processors, further cause the user device to display an icon selectable to cause the one or more gestures to be provided to the gesture recognition algorithm, and wherein the providing of the one or more gestures to the gesture recognition algorithm is performed responsive to receiving a selection of the icon via the GUI.
7. The one or more tangible, non-transitory computer readable media of any one of aspects 1 to 6, wherein the instructions to provide the one or more gestures to the gesture recognition algorithm include instructions to (1) transmit an indication of the one or more gestures over a network to one or more servers, the one or more servers being configured to implement the gesture recognition algorithm, and (2) receive, from the server over the network, an indication of the identified process entity.
8. The one or more tangible, non-transitory computer readable media of any one of aspects 1 to 7, wherein the instructions, when executed by the one or more processors, further cause one or more processors to display, via the GUI, a visual element indicating the process identity being identified via the gesture recognition algorithm, and wherein the displaying of the instance of the template object in the canvas region is performed responsive to receiving a selection of the visual element by the user via the GUI.
9. The one or more tangible, non-transitory computer readable media of any one of aspects 1 to 8, wherein identifying the process entity includes (1) obtaining, via the gesture recognition algorithm, an indication of two or more candidate process entities, (2) displaying, via the GUI, a menu indicating the two or more candidate process entities, (3) receiving, from the user via the menu, a selection of a particular process entity from among the two or more candidate process entities, and (4) identifying the selected process entity as the process entity represented by the one or more gestures.
10. The one or more tangible, non-transitory computer readable media of aspect 9, wherein the instructions, when executed by the one or more processors, further cause the user device to cause the gesture recognition algorithm to be adapted based upon the selection of the particular process entity from among the two or more candidate process entities.
11. The one or more tangible, non-transitory computer readable media of any one of aspects 1 to 10, wherein the identification of the process entity by the gesture recognition algorithm is further based upon a location in the gesture input region at which the one or more gestures were received, with respect to locations of one or more other template object instances in the canvas region.
12. The one or more tangible, non-transitory computer readable media of any one of aspects 1 to 11, wherein displaying the instance of the template object in the canvas region comprises automatically adjusting a size or location of the instance of the template object in the canvas region.
13. The one or more tangible, non-transitory computer readable media of aspect 12, wherein automatically adjusting the size or location of the instance of the template object comprises snapping an edge of the instance of the template object to at least one other template object instance in the canvas region.
14. The one or more tangible, non-transitory computer readable media of any one of aspects 1 to 13, wherein the instructions, when executed via the one or more processors, further cause the user device to (1) display a configuration region of the GUI, and (2) receive, via the configuration region of the GUI, a plurality of user interactions to associate the process display with process entities included at least a portion of the process plant, to facilitate operation of the process display using on-line process data from the at least the portion of the process plant.
15. The one or more tangible, non-transitory computer readable media of any one of aspects 1 to 14, wherein the instructions, when executed via the one or more processors, further cause the user device to upload the process display to one or more servers.
16. The one or more tangible, non-transitory computer readable media of any one of aspects 1 to 15, wherein the instructions, when executed via the one or more processors, further cause the user device to download the process display to one or more other devices for viewing of the process display at the one or more other devices during on-line operation of the process plant.
17. The one or more tangible, non-transitory computer readable media of any one of aspects 1 to 16, wherein the instructions, when executed via the one or more processors, further cause the user device to define, based upon one or more user interactions received via the GUI, a new association between one or more user-defined lines or shapes and a particular process entity having a corresponding template.
18. The one or more tangible, non-transitory computer readable media of aspect 17, wherein the instructions, when executed via the one or more processors, further cause the user device to cause the gesture recognition algorithm to be adapted to recognize the one or more user-defined lines or shapes as corresponding to the particular process entity.
19. The one or more tangible, non-transitory computer readable media of any one of aspects 1 to 18, wherein the instructions, when executed via the one or more processors, further cause the user device to modify one or more properties of the displayed instance of the template object in response to one or more further user interactions received via the GUI.
20. The one or more tangible, non-transitory computer readable media of aspect 19, wherein the one or more properties include an animation.
21. The one or more tangible, non-transitory computer readable media of aspect 19 or aspect 20, wherein the one or more properties include an event handler behavior.
22. The one or more tangible, non-transitory computer readable media of any one of aspects 19 to 21, wherein the one or more properties include a physical dimension.
23. The one or more tangible, non-transitory computer readable media of any one of aspects 1 to 22 in combination with any other suitable one of aspects 1 to 22.
24. A computer-implemented method comprising (1) receiving, via the one or more processors, forming at least one line or shape in a gesture input region, the one or more gestures being provided by a user, (2) via the one or more processors, providing the one or more gestures as one or more inputs to a gesture recognition algorithm to identify, based at least upon the received one or more gestures, a process entity represented by the received one or more gestures, the process entity being identified from among a plurality of process entities having respective template objects associated therewith, and (3) based upon the identification of the process entity, display, via the one or more processors, in the canvas region of a graphical user interface (GUI) executing at a user device, an instance of a template object corresponding to the identified process entity, the template object being configured to provide a visual representation of operation of the identified process entity in a process plant to thereby form at least a portion of a process display.
25. The computer-implemented method of aspect 24, further comprising the actions performed via the user device of any of aspects 1 to 23.
26. A user device comprising one or more processors, a display, and one or more non-transitory computer memories storing machine-readable instructions that, when executed by the one or more processors, cause the user device to (1) receive one or more gestures forming at least one line or shape in a gesture input region, the one or more gestures being provided by a user, (2) provide the one or more gestures as one or more inputs to a gesture recognition algorithm to identify, based at least upon the received one or more gestures, a process entity represented by the received one or more gestures, the process entity being identified from among a plurality of process entities having respective template objects associated therewith, and (3) based upon the identification of the process entity, display, in a canvas region of a graphical user interface (GUI) executing via the user device, of an instance of a template object corresponding to the identified process entity, the template object being configured to provide a visual representation of operation of the identified process entity in a process plant to thereby form at least a portion of a process display.
27. The user device of aspect 26, configured via the machine-readable instructions of any one of aspects 1 to 23.
28. The user device of aspect 26, configured to perform the actions of aspect 24 or aspect 25.
29. Any one of aspects 1 to 27 in combination with any other suitable one of aspects 1 to 27.

What is claimed is:

1. One or more tangible, non-transitory computer readable media storing machine-readable instructions that, when executed by one or more processors of user device, cause the user device to:
receive one or more gestures forming at least one line or shape in a gesture input region, the one or more gestures being provided by a user;
provide the one or more gestures as one or more inputs to a gesture recognition algorithm to identify, based at least upon the received one or more gestures, a process entity represented by the received one or more gestures, the process entity being identified from among a plurality of process entities having respective template objects associated therewith; and
based upon the identification of the process entity, display, in a canvas region of a graphical user interface (GUI) executing via the user device, of an instance of a template object corresponding to the identified process entity, the template object being configured to provide a visual representation of operation of the identified process entity in a process plant to thereby form at least a portion of a process display.

2. The one or more tangible, non-transitory computer readable media of claim 1, wherein receiving the one or more gestures comprises detecting the one or more gestures via one or more cameras associated with the user device.

3. The one or more tangible, non-transitory computer readable media of claim 1, wherein the gesture input region is the canvas region of the GUI, and wherein the one or more gestures are received via one or more touch interactions corresponding to the canvas region.

4. The one or more tangible, non-transitory computer readable media of claim 3, wherein the canvas region is displayed via a visual display of the user device, and wherein the one or more gestures are received via the one or more touch interactions at a touch-aware surface separate from the visual display of the user device, and wherein receiving the one or more gestures comprises mapping respective locations of the one or more touch interactions at the touch-aware surface to a corresponding respective locations of the visual display.

5. The one or more tangible, non-transitory computer readable media of claim 1, wherein the instructions, when executed by the one or more processors, further cause the user device to display the at least one line or shape in the canvas region of the GUI upon receiving the one or more gestures.

6. The one or more tangible, non-transitory computer readable media of claim 5, wherein the instructions, when executed by the one or more processors, further cause the user device to display an icon selectable to cause the one or more gestures to be provided to the gesture recognition algorithm, and wherein the providing of the one or more gestures to the gesture recognition algorithm is performed responsive to receiving a selection of the icon via the GUI.

7. The one or more tangible, non-transitory computer readable media of claim 1, wherein the instructions to provide the one or more gestures to the gesture recognition algorithm include instructions to:
transmit an indication of the one or more gestures over a network to one or more servers, the one or more servers being configured to implement the gesture recognition algorithm; and
receive, from the server over the network, an indication of the identified process entity.

8. The one or more tangible, non-transitory computer readable media of claim 1, wherein the instructions, when executed by the one or more processors, further cause the user device to display, via the GUI, a visual element indicating the process identity being identified via the gesture recognition algorithm,
and wherein the displaying of the instance of the template object in the canvas region is performed responsive to receiving a selection of the visual element by the user via the GUI.

9. The one or more tangible, non-transitory computer readable media of claim 1, wherein identifying the process entity includes:
obtaining, via the gesture recognition algorithm, an indication of two or more candidate process entities;
displaying, via the GUI, a menu indicating the two or more candidate process entities;
receiving, from the user via the menu, a selection of a particular process entity from among the two or more candidate process entities; and
identifying the selected process entity as the process entity represented by the one or more gestures.

10. The one or more tangible, non-transitory computer readable media of claim 9, wherein the instructions, when executed by the one or more processors, further cause the user device to cause the gesture recognition algorithm to be adapted based upon the selection of the particular process entity from among the two or more candidate process entities.

11. The one or more tangible, non-transitory computer readable media of claim 1, wherein the identification of the process entity by the gesture recognition algorithm is further based upon a location in the gesture input region at which the one or more gestures were received, with respect to locations of one or more other template object instances in the canvas region.

12. The one or more tangible, non-transitory computer readable media of claim 1, wherein displaying the instance of the template object in the canvas region comprises automatically adjusting a size or location of the instance of the template object in the canvas region.

13. The one or more tangible, non-transitory computer readable media of claim 12, wherein automatically adjusting the size or location of the instance of the template object comprises snapping an edge of the instance of the template object to at least one other template object instance in the canvas region.

14. The one or more tangible, non-transitory computer readable media of claim 1, wherein the instructions, when executed via the one or more processors, further cause the user device to:
display a configuration region of the GUI; and
receive, via the configuration region of the GUI, a plurality of user interactions to associate the process display with process entities included at least a portion of the process plant, to facilitate operation of the process display using on-line process data from the at least the portion of the process plant.

15. The one or more tangible, non-transitory computer readable media of claim 1, wherein the instructions, when executed via the one or more processors, further cause the user device to upload the process display to one or more servers.

16. The one or more tangible, non-transitory computer readable media of claim 1, wherein the instructions, when executed via the one or more processors, further cause the user device to download the process display to one or more other devices for viewing of the process display at the one or more other devices during on-line operation of the process plant.

17. The one or more tangible, non-transitory computer readable media of claim 1, wherein the instructions, when executed via the one or more processors, further cause the user device to define, based upon one or more user interactions received via the GUI, a new association between one or more user-defined lines or shapes and a particular process entity having a corresponding template.

18. The one or more tangible, non-transitory computer readable media of claim 17, wherein the instructions, when executed via the one or more processors, further cause the user device to cause the gesture recognition algorithm to be adapted to recognize the one or more user-defined lines or shapes as corresponding to the particular process entity.

19. The one or more tangible, non-transitory computer readable media of claim 1, wherein the instructions, when executed via the one or more processors, further cause the user device to modify one or more properties of the displayed instance of the template object in response to one or more further user interactions received via the GUI.

20. The one or more tangible, non-transitory computer readable media of claim 19, wherein the one or more properties include an animation.

21. The one or more tangible, non-transitory computer readable media of claim 19, wherein the one or more properties include an event handler behavior.

22. The one or more tangible, non-transitory computer readable media of claim 19, wherein the one or more properties include a physical dimension.

23. A computer-implemented method comprising:
receiving, via one or more processors, one or more gestures forming at least one line or shape in a gesture input region, the one or more gestures being provided by a user;
via the one or more processors, providing the one or more gestures as one or more inputs to a gesture recognition algorithm to identify, based at least upon the received one or more gestures, a process entity represented by the received one or more gestures, the process entity being identified from among a plurality of process entities having respective template objects associated therewith; and
based upon the identification of the process entity, display, via the one or more processors, in a canvas region of a graphical user interface (GUI) executing at a user device, an instance of a template object corresponding to the identified process entity, the template object being configured to provide a visual representation of operation of the identified process entity in a process plant to thereby form at least a portion of a process display.

24. A user device comprising:
one or more processors;
a display; and
one or more non-transitory computer memories storing machine-readable instructions that, when executed by the one or more processors, cause the user device to:
receive one or more gestures forming at least one line or shape in a gesture input region, the one or more gestures being provided by a user;
provide the one or more gestures as one or more inputs to a gesture recognition algorithm to identify, based at least upon the received one or more gestures, a process entity represented by the received one or more gestures, the process entity being identified from among a plurality of process entities having respective template objects associated therewith; and
based upon the identification of the process entity, display, in a canvas region of a graphical user interface (GUI) executing via the user device, of an instance of a template object corresponding to the identified process entity, the template object being configured to provide a visual representation of operation of the identified process entity in a process plant to thereby form at least a portion of a process display.
